(19) United States
(12) Patent Application Publication
(10) Pub. No.: US 2017/0300372 A1
(43) Pub. Date: Oct. 19, 2017

(54) METHOD AND APPARATUS FOR THE DETECTION OF FAULTS IN DATA COMPUTATIONS

(71) Applicant: UCL BUSINESS PLC, London (GB)

(72) Inventors: IOANNIS ANDREOPOULOS, London (GB); MOHAMMAD ASHRAFUL ANAM, London (GB)

(21) Appl. No.: 15/508,513

(22) PCT Filed: Sep. 2, 2015
(86) PCT No.: PCT/GB2015/052533

§ 371 Date: Mar. 3, 2017

(30) Foreign Application Priority Data
Sep. 3, 2014 (GB) 1415567.5

(51) Int. Cl. G06F 11/07; G06F 7/50

(52) U.S. Cl. CPC G06F 11/079; G06F 11/0751; G06F 7/50; G06F 11/0706

(57) ABSTRACT

A method and apparatus for detecting and mitigating faults in numerical computations of M input data streams is claimed (embodiments of FIG. 1 and FIG. 14). Such faults may occur due to circuit or processor malfunctions stemming from (but not limited to): supply voltage or current fluctuation, timing signal errors, hardware device noise, or other signalling, hardware, or software non-idealities. The invented method and apparatus for numerical entanglement linearly superimposes M input data streams to form M numerically-entangled data streams that can optionally be stored in-place of the original inputs (as in the example embodiments of: Step 2 of FIG. 1 and item 1054 of FIG. 14). A series of operations, such as (but not limited to): scaling, additions/subtractions, inner or outer vector or matrix products and permutations, can then be performed directly using these entangled data streams (as in the example embodiment of Step 3 of FIG. 1, operator g of FIG. 2, FIGS. 6-11, item 1053 of FIG. 14). The output results are disentangled from the M entangled output streams by additions and arithmetic shifts (example embodiments of Steps 4 and 5 of FIG. 1, “disentanglement and fault checking” of FIG. 2, item 1056 of FIG. 14). A post-computation reliability check detects processing errors affecting disentangled outputs (example embodiments of item 1056 of FIG. 14, FIGS. 15a, 15b, 16a, 16b, 17a, 17b).

### TECHNICAL FIELD

The present invention relates to the detection of faults in numerical processing by computer hardware or software. Particularly, aspects relate to a method of fault detection in data streams via a process of numerical entanglement, followed by the application of data computation, a numerical disentanglement process and a fault checking process.

### BACKGROUND TO THE INVENTION

Fault detection is often employed in fault-generating computer hardware, such as complementary metal-oxide semiconductor (CMOS) transistor technology or other computing technology. Increases in the complexity of such hardware (for example, increased integration density of future CMOS technologies) are expected to require improved levels of resilience to transient faults, caused by process variation or other soft errors (for example, errors caused by particle strikes and circuit overclocking or undervolting [1]). This is of particular importance to applications in mobile, desktop and high-performance systems (for example, webpage or multimedia retrieval [2], relevance ranking [3], object of face recognition in images [4], machine learning and security applications [5], financial computing [6], low-power image and video compression [7], resilience to transmission errors via coding methods [8]).

Such systems employ algorithms comprising linear, sesquilinear (also known as one-and-half linear) and bijective (LSB) operations. Such operations are performed using single or double precision floating-point arithmetic or, for high-performance systems requiring exact reproducibility and reduced hardware complexity, 32-bit or 64-bit integer or fixed-point arithmetic. Examples of LSB operations include data copy and data storage operations, element-by-element additions and multiplications, sum-of-products, sum-of-squares and permutation operations. Therefore, it is important to obtain robustness to arbitrary transient errors in hardware, thus ensuring highly reliable LSB operations with minimal overhead. Existing techniques that can ensure reliability to computational or memory faults include software or hardware (circuit-level) error correcting codes (ECC), algorithm-based fault-tolerance (ABFT) approaches and systems with double or triple modular redundancy (MR). Such techniques can lead to substantial processing overhead in software and hardware systems, and can also cause increased energy consumption. Furthermore, ECC and ABFT techniques can only detect up to a limited number of errors (typically 1 to 3) [11][12]. Therefore, since hardware faults tend to happen in bursts [1][14], ECC and ABFT techniques are not an ideal way of detecting arbitrary error patterns (faults) occurring in 32-bit or 64-bit data representations in memory, arithmetic or logic units of such hardware. Conversely, MR systems can detect any number of errors and, therefore, detect arbitrary error patterns with high responsibility on a single processor. However, the same operation must be performed in parallel in two or three separate processors to cross-validate the results [13] and consequently, incur a two-fold or three-fold penalty in execution time or energy consumption, as well as requiring substantial data transfers and latencies in order to synchronise and cross-validate results [13].

### SUMMARY OF THE INVENTION

Embodiments of the present invention address the above noted deficiencies in fault detection and the performance of numerical operations on encrypted inputs by providing a method and apparatus for detecting faults and errors arising in numerically entangled streams of data, particularly those occurring as a result of computations (for example, LSB operations), which guarantees increased fault detection capabilities and in some cases allows input/output data obfuscation with minimal processing overhead. Embodiments of the present invention implement a new technique on a plurality of input data streams, denoted as numerical entanglement, in which pairs of input data values (typically stemming from different input data streams) are scaled by a predetermined factor and added or subtracted, such that the vast majority of their original binary representation becomes numerically entangled (i.e. superimposed onto each other) into the numerical representation of the resulting value. Computations may then be performed directly using the plurality of numerically entangled input data streams to produce a plurality of numerically entangled output data streams. The final output results are then extracted from the plurality of numerically entangled output data streams via a numerical disentanglement process comprising bit masking and shift-add operations. The processes of numerical entanglement and disentanglement will be described in further detail in the detailed description below.

In some embodiments if the parameters of the utilized numerical entanglement process are kept private as a “numerical entanglement key”, i.e. the positions of the input data values that are paired into a single numerically entangled input data value (or the parameters of the algorithm that derives them), then an avenue for computation with encrypted or obfuscated data is provided, wherein the computation unit(s) used for the performed LSB operations do not have access to the original input data values but only to the numerically entangled version of them. Without the numerical entanglement key, the number of operations required to disentangle the output data streams grows proportionally to the number of numerically entangled output data streams Mₒᵤₜ×(Mₒᵤₜ !) (i.e. faster than all polynomial or exponential functions of Mₒᵤₜ). As such, under a sufficiently large number of output data streams, the numerically entangled data can only be disentangled with the numerical entanglement key.

Once the final results have been extracted, the present invention performs a specific reliability check to validate these results. The fault checking process comprises further bit masking or modulo operations, scaling and addition/subtraction operations, and guarantees the detection of any fault incurred within any single numerically entangled output data stream out of all of the plurality of numerically entangled output data streams available. The specific fault checks will also be described further in the detailed description that follows. Importantly, the number of operations required to numerically entangle, numerically disentangle, and then validate the data streams depends only on the number of input data samples contained in each of the input and output data streams, and is not affected by the complexity of any computations performed on the entangled data streams. As a result, as the number of computations per input data sample increases, the percentile implementation overhead of the fault checking process diminishes to near-zero. Therefore, the present invention provides fault detection capabilities similar to those of a modular redundancy system without the substantial processing overhead.

In view of the above, one aspect of the invention provides a method of fault detection in data computations which comprises performing a numerical entanglement process including receiving a plurality of data streams comprising a plurality of input data values, wherein each input data value is combined with a second input data value. In some embodiments the combination comprises for each pair of input data values, one input data value being scaled with a predetermined factor and added or subtracted to the other input data value to produce the plurality of numerically entangled input data streams to be used in data computations that produce a plurality of numerically entangled output data streams. The method then further comprises performing a numerical disentanglement process on the plurality of numerically entangled output data streams, wherein in-stream positions of the numerically entangled input data values within each numerically entangled input data stream are mapped to the in-stream positions of the numerically entangled output data values within each numerically entangled output data stream, and wherein the numerical entanglement process is subsequently reversed based on the mapped positions to produce a plurality of numerically disentangled output data streams. A fault checking process is then performed on the plurality of numerically disentangled output data streams. In some embodiments the fault checking comprises an intermediate form of the plurality of numerically entangled output data streams being produced, wherein the data values contained within corresponding locations and numerical ranges of each data stream of the intermediate form are compared to identify at least one fault in the data computation.

Any data computations performed on the numerically entangled input data values produce the same final output data values as when performed on the original input data and, without the numerical entanglement parameters, the computational units used for any such data computations cannot obtain the original input data or the final output data.

In one embodiment of the invention, Mᵢₙ input data streams of Nᵢₙ input data values are received, wherein Mᵢₙ≧1, Nᵢₙ≧1 and Mᵢₙ+Nᵢₙ≧3. Preferably, the numerical entanglement process produces Mᵢₙ×Nᵢₙ numerically entangled inputs and the processing produces Mₒᵤₜ data streams of Nₒᵤₜ numerically entangled output data values, such that there are Mₒᵤₜ×Nₒᵤₜ numerically entangled outputs. It should be noted that the implementation complexity of the numerical entanglement, disentanglement and fault-checking method depends linearly on Mᵢₙ and Nᵢₙ and not on the complexity of the data processing performed on the numerically entangled input data streams.

Preferably, the data computations on the plurality of numerically entangled input data streams include performing at least one linear, sesquilinear or bijective (LSB) operations. LSB operations are the building blocks of most algorithms used in computing technology and, therefore, commonly applied to integer data streams. The nature of the numerically entangled input data streams means that performing any LSB operations on the numerically entangled input data streams has the same technical effect as performing the same LSB operations on the original input data streams, such that the numerically entangled output data streams contain the final output results after any LSB processing. That is to say, the final output results obtained in the present invention after numerical disentanglement will be the same as the outputs obtained if the LSB operations were applied directly to the original input data streams. As indicated above, the complexity of the LSB operations has no effect on the implementation complexity of the method.

In another embodiment, the data values within each pair of input data values are selected from within the same input data stream, or from within two different input data streams. That is to say, any two input data values may be paired together and numerically entangled. Preferably, the stream number and in-stream position of each pair of input data values, or the parameters from which each pair of input data values are selected, are kept separate from the input data as a numerical entanglement key. This numerical entanglement key enables data obfuscation and provides an avenue towards computation with encrypted data.

Preferably, mapping the in-stream positions of the numerically entangled input data values within each of the numerically entangled input data streams to the in-stream positions of the numerically entangled output data values within each numerically entangled input data stream is conducted according to the order by which data computations were performed on the numerically entangled input data streams to produce the numerically entangled output data streams.

In another preferred embodiment, Mᵢₙ=2M+1 input data streams are received, with M≧1, and wherein the plurality of numerically entangled input data streams or output data streams are contained within a w-bit integer representation, wherein the dynamic range of the w-bit integer representation is larger or equal to (2M+1)l-bits, such that (2M+1)l≦w, and wherein the dynamic range of the numerically entangled data streams is not greater than (2M+1)l bits. For example, w=32 with l=10 and M=1 for three numerically entangled input data streams, such that two bits are left over, one unused bit and one for the sign of the entangled data streams. In order to achieve the successful numerical disentanglement of the output results, as well as the detection of faults in the entangled input or output data streams, the original input data streams should not be larger than 2Ml bits. Thus, l bits of dynamic range must be used within the w-bit integer representation for the purpose of numerical entanglement. For example, while the dynamic range of a 32-bit number allows for three zones of l=10 bits each, only two zones can be used by each input sample, that is to say, each input sample of the data can have dynamic range no greater than 20 bits.

According to one embodiment of the present invention, the fault checking process includes M intermediate steps for each numerically entangled output data value of each 2M+1 numerically entangled output data stream, each intermediate step producing another 2M+1 numerically entangled output data streams, wherein the offset between the 2M+1 numerically entangled output data streams increases by l-bits with each intermediate step. The M intermediate steps are required where the integer outputs are signed integers, the M steps being conducted in order to process the 2M+1 numerically entangled output data streams in a form where each section of the w-bit integer representation may be checked for a fault, such that the output data streams within each entanglement overlap by Ml-bits. As a result, each section of the integer representation (top, middle and bottom) will contain Ml-bits, thus allowing each section to be checked against one another to verify that the final output results are valid. Moreover, this allows any error in each section to be detected and identified.

According to one aspect of this embodiment, the fault checking process includes 4M+3 checks for each group of 2M+1 numerically entangled output data streams. Namely, 2M+1 checks for each numerically entangled output data stream produced for by the M intermediate steps, 2M+1 checks for each section of the w-bit integer representation, and one final check for all of the combined sections. Therefore, the number of checks required in the fault-checking process is linearly related to the number of output data streams and does not depend on the complexity of any data processing, such as LSB operations, conducted on the data streams.

In another embodiment, the numerical entanglement process includes scaling one of the input data values within the pairs of input data values by a factor dependent on l, and subsequently adding or subtracting the second input data value within the pair, wherein the numerically entangled input data streams may have an increased dynamic range in comparison to the input data values by a factor dependent on l.

Further to this, the numerical disentanglement process may be based on the application of at least on of scaling by a factor dependent on l, addition operations, subtraction operations, modulo operations or bit-masking operations. The application of such operations effectively reverses the numerical entanglement process in order to extract the final output data values.

According to another embodiment, producing the intermediate form of the plurality of numerically entangled output data streams may be based on the in-stream positions of the numerically entangled input data values within the numerically entangled input data streams, and further performed by scaling the numerically entangled output data values with a factor dependent on l.

In another embodiment of the present invention, the input data values comprise signed or unsigned integer numbers and the process of numerical entanglement includes linear combinations of pairs of input data values, wherein one input data value is left-shifted by l bits using a shift register and added to another input data value to form a single numerically entangled input data value.

Preferably, the fault checking process includes checking that the data values contained within corresponding locations and numerical ranges of each numerically entangled output data stream of the intermediate form are identical, and wherein data values contained within corresponding locations and numerical ranges of each numerically entangled output data stream of the intermediate form that are not identical indicate the presence of a fault. That is to say, corresponding sections of the integer representation (top, middle and bottom), each comprising l-bits of data, of each numerically entangled output data stream of the intermediate form are compared and validated.

In one preferred embodiment of the present invention, the numerical entanglement process includes the selection of pairs of input data values by repeating a series of steps until all of the available input data values have been selected. The steps include selecting at random one input data stream from the plurality of input data streams, but excluding previously selected input data streams, and within each selected input data stream, selecting each of its input data values sequentially or via some fixed pattern. Each selected input data value may then be paired with a second input data value, wherein the second input data value is selected from the corresponding position of the next input data stream, and the positions of each pair of input data values, or the manner via which the random selection is performed, may be kept as the numerical entanglement key.

According to another embodiment, any fault occurring within any single numerically entangled output data stream out of the plurality of numerically entangled output data streams is detected. The numerically entangled integer representation of the present invention allows each portion of dynamic range (l-bits) within the w-bit integer representation to be checked for faults, wherein the checks may be conducted for each numerically entangled output data stream. Therefore, the validity of the final disentangled outputs may be verified to ensure no faults have occurred during any data computations performed on the numerically entangled input data streams.

According to a further embodiment of the present invention, the cycle overhead of performing the numerical entanglement, numerical disentanglement and fault checking is less than 5%. Therefore, the present invention can provide increased fault detection capabilities with minimal overhead. In particular, the overhead diminishes to near-zero as the number of LSB operations per input sample increases. Consequently, the present invention ensures highly reliable integer LSB operations with minimal overhead.

In one embodiment, all steps of the process are performed for a group of inputs before applying the steps to the remaining inputs. In another embodiment of the present invention, each step is performed in the entirety of inputs before moving to the next step.

In one embodiment, Mᵢₙ numerically entangled input data streams are produced in a secure or trustworthy apparatus, the parameters of the numerical entanglement process being kept in the secure or trustworthy apparatus, and data computations being performed on M′ᵢₙ out of the Mᵢₙ numerically entangled input data streams, wherein 1≦Mᵢₙ′<Mᵢₙ, in the secure or trustworthy apparatus. Data computations are performed on the remaining Mᵢₙ−M′ᵢₙ numerically entangled input data streams in an insecure or untrustworthy apparatus. For example, the numerically entangled input data streams may be sent to a cloud computing infrastructure that may be unreliable and untrustworthy, with the parameters of the numerical entanglement being kept private. The external computing system does not have access to all of the data streams, or possess the information needed to disentangle the numerically entangled data streams and, therefore, it is impossible for the external computing system to extract the numerically disentangled input or output data streams.

In another embodiment, Mᵢₙ numerically entangled input data streams are produced and data computations are performed on the numerically entangled input data streams by an external apparatus over a computer network, or by a cloud computing infrastructure, or by a separate processor core over a multicore or manycore computing system, wherein such apparatus are unreliable and/or untrustworthy. Provided the parameters of the numerical entanglement process are kept private, it is impossible for the external system to extract the numerically disentangled input or output data streams.

Another aspect of the present invention provides an apparatus for performing computations on data and detecting faults comprising means for receiving a plurality of data streams comprising a plurality of input data values, means for producing a plurality of numerically entangled input data streams, wherein each received input data value is paired with a second input data value, and wherein, for each pair of input data values, one input data value is scaled with a predetermined factor, and wherein the second input data value is subsequently added or subtracted to produce the plurality of numerically entangled input data streams to be used in data computations that produce a plurality of numerically entangled output data streams. The apparatus further comprises means for performing a numerical disentanglement process on the plurality of numerically entangled output data streams, wherein the in-stream positions of the numerically entangled input data values within each numerically entangled input data stream are mapped to the in-stream positions of the numerically entangled output data values within each numerically entangled output data stream, and wherein the numerical entanglement process is subsequently reversed based on the mapped positions to produce a plurality of numerically disentangled output data streams, and means for performing a fault checking process on the plurality of numerically disentangled output data streams, wherein an intermediate form of the plurality of numerically disentangled output data streams are produced, wherein the data values contained within corresponding locations and numerical ranges of each data stream of the intermediate form are compared to identify at least one fault in the data computation.

A further aspect of the present invention provides an apparatus for performing computations on data and detecting faults comprising a processor, and a computer readable medium, the computer readable medium storing one or more machine instruction(s) is arranged such that when executed the processor is caused to receive a plurality of data streams comprising a plurality of input data values, produce a plurality of numerically entangled input data streams, wherein each received input data value is paired with a second input data value, and wherein, for each pair of input data values, one input data value is scaled with a predetermined factor, and wherein the second input data value is subsequently added or subtracted to produce the plurality of numerically entangled input data streams to be used in data computations that produce a plurality of numerically entangled data streams. The processor is further caused to perform a numerical disentanglement process on the plurality of numerically entangled output data streams, wherein the in-stream positions of the numerically entangled input data values within each numerically entangled input data stream are mapped to the in-stream positions of the numerically entangled output data values within each numerically entangled output data stream, and wherein the numerical entanglement process is subsequently reversed based on the mapped positions to produce a plurality of numerically disentangled output data streams, and perform a fault checking process on the plurality of numerically disentangled output data streams, wherein an intermediate form of the plurality of numerically disentangled output data streams are produced, wherein the data values contained within corresponding locations and numerical ranges of each data stream of the intermediate form are compared to identify at least one fault in the data computation. Preferably, the apparatus is a secure or trustworthy system.

In another aspect, the present invention provides a fault detection method for detecting faults in data computations, which comprises receiving a plurality of input data words intended as operands in a data computation to be performed, mixing elements of the plurality of data words together in a predetermined manner to produce a plurality of mixed data words to be used as operands in one or more data computations, the data computations providing a plurality of output mixed data words, separating the plurality of output mixed data words into a plurality of output data words, and checking for faults in the one or more data computations by evaluating one or more predefined numerical expressions using elements of the output data words as variables therein.

Preferably, a fault is detected if the predefined numerical expressions are found to be true.

In a further aspect, an apparatus is provided for performing computations on data and detecting faults, comprising a processor and a computer readable medium. The computer readable medium storing one or more machine instruction(s) is arranged such that when executed the processor is caused to receive a plurality of input data words intended as operands in a data computation to be performed, mix elements of the plurality of data words together in a predetermined manner to produce a plurality of mixed data words to be used as operands in one or more data computations, the computations providing a plurality of output mixed data words, separate the plurality of output mixed data words into a plurality of output data words, and check for faults in the one or more computations by evaluating one or more predefined numerical expressions using elements of the output data words as variables therein.

### BRIEF DESCRIPTION OF THE DRAWINGS

The present invention will now be described by way of example only, and with reference to the accompanying drawings in which:

FIG. 1 is a flow diagram illustrating the fault detection method of the present invention;

FIG. 2 is a flow diagram illustrating LSB processing of data streams via numerical entanglement, followed by disentanglement and fault checking;

FIG. 3 provides flow diagrams illustrating (a) kernel g applied to 2M+1 streams of input integers via LSB operations, and (b) corresponding application of LSB operations to 2M+1 input streams and P redundant input streams used for fault detection in ECC/ABFT/MR techniques;

FIG. 4 is a table summarizing the features of different techniques used for fault detection;

FIG. 5a illustrates the basic framework for Numerical Packing and shows the non-overlapped packing of two operands;

FIG. 5b illustrates the basic framework for Numerical Packing and shows the overlapped packing of two operands;

FIG. 6 illustrates entanglement of 2M+1 input data streams via linear superposition;

FIG. 7 illustrates the first intermediate representation for 2M+1 entanglements;

FIG. 8 illustrates the final intermediate representation for 2M+1 entanglements which is subsequently used for error checking;

FIG. 9 illustrates entanglement via linear superposition of three integer input data streams;

FIG. 10 illustrates entanglement via linear superposition of five integer input data streams;

FIG. 11 illustrates the intermediate representation, used in the disentanglement and fault-checking process of five integer output data streams;

FIG. 12a illustrates the ratios of operations for numerical entanglement, disentanglement and fault checking versus: (i) generic matrix multiplication, (ii) time-domain convolution and (iii) frequency-domain convolution;

FIG. 12b illustrates the ratios of operations for ECC/ABFT generation and fault checking versus: (i) generic matrix multiplication, (ii) time-domain convolution and (iii) frequency-domain convolution;

FIG. 13 illustrates examples of applications of the present invention;

FIG. 14 is a block diagram showing an apparatus according to an embodiment of the present invention;

FIG. 15a illustrates an apparatus according to an embodiment of the present invention wherein the present invention is used for encrypted computing or computing with obfuscated data;

FIG. 15b further illustrates an apparatus according to an embodiment of the present invention wherein the present invention is used for encrypted computing or computing with obfuscated data;

FIG. 16a illustrates an apparatus according to an embodiment of the present invention wherein a processor cluster implements the present invention for voltage and frequency over-scaling with guaranteed reliability;

FIG. 16b further illustrates an apparatus according to an embodiment of the present invention wherein a processor cluster implements the present invention for voltage and frequency over-scaling with guaranteed reliability;

FIG. 17a illustrates an apparatus according to an embodiment of the present invention wherein a processor cluster that has failed quality-assurance checks is used in conjunction with the present invention for guaranteed reliability of LSB operations;

FIG. 17b further illustrates an apparatus according to an embodiment of the present invention wherein a processor cluster that has failed quality-assurance checks is used in conjunction with the present invention for guaranteed reliability of LSB operations.

### DETAILED DESCRIPTION

Overview

The present invention proposes a new method to detect faults in linear, sesquilinear (also known as one-and-half linear) or bijective operations performed in integer data streams with integer arithmetic units. Examples of such operations are element-by-element additions and multiplications, sum-of-products, sum-of-squares and permutation operations. These operations are the building blocks of algorithms of foundational importance, such as matrix multiplication, convolution/cross-correlation, template matching for search algorithms, covariance calculations, integer-to-integer transforms, sorting and permutation-based encoding systems [15].

It should be noted that if said algorithms are data-dependent, such as sorting algorithms where the performed permutations depend on the element values, then the algorithmic steps will need to be modified to accommodate for the utilized entangled representation. However, for LSB operations that are not data-dependent (e.g. permutation according to fixed index sets or fixed linear or sesquilinear operators), then no algorithmic modification is required. The algorithm-specific modifications required to accommodate data-dependent LSB operators remain outside the scope of the present invention.

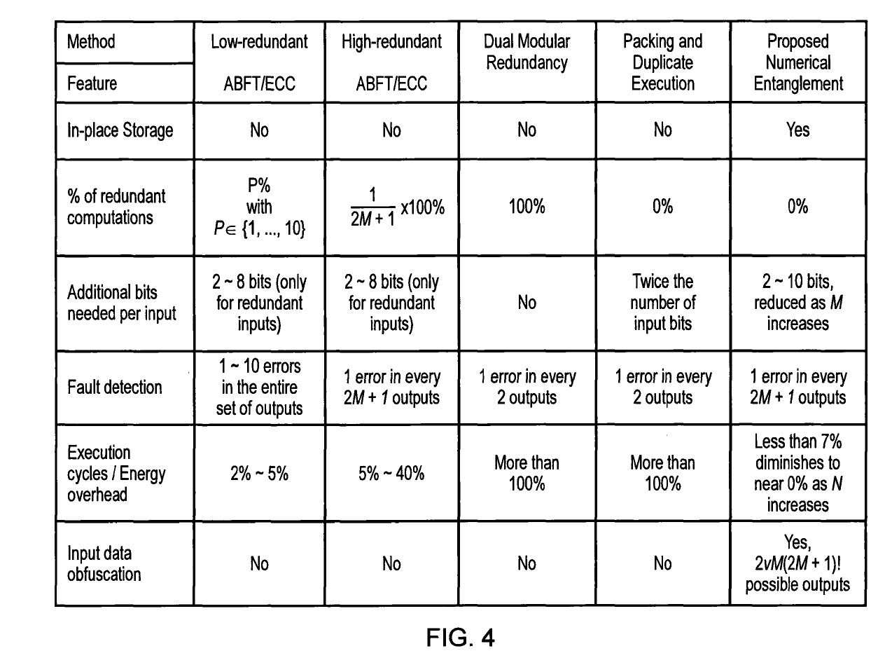

The present invention is neither ECC/ABFT/MR-based and is considered to be a completely new approach. To exemplify the key differences between the present invention and the techniques known in the art, FIG. 4 provides a summary of different methods of fault detection, including ECC/ABFT and MR methods, along with the Numerical Packing, a precursor of this invention, the features of which will be described below.

The invention does not require any modifications to the arithmetic units and can be deployed in standard 32/64-bit integer units or even 32/64-bit floating-point units, and, furthermore, does not depend on the specifics of the LSB operation that is performed. In fact, it can also be used to detect errors in data storage, that is when no computation is performed with the data. Additionally, the invention does not allow for the input data of any stream to be extracted unless all 2M+1 entangled data streams are available. Even when all of the entangled inputs or outputs of LSB processing are available, 2M(2M+1)! operations are required to recover their original values when the entanglement mixture parameters are kept private. This obfuscation property provides for inherent resistance to tampering within any single entangled description and may provide for a practical avenue towards encrypted computation.

Error Correcting Codes, Algorithm-Based Fault-Tolerance and Modular Redundancy

Consider a series of Mᵢₙ=2M+1 input streams of integers, each comprising Nᵢₙ=N samples (M, N∈□*):

cₘ=[c_{m,0}, . . . ,c_{m,N-1},],0≦m<2M+1 (1)

These may be the elements of 2M+1 rows of a matrix of integers, or a set of 2M+1 input integer streams of data to be operated upon with an integer kernel g. This operation is performed by:

$$∀ m : {d}_{m} = {c}_{m} op g , op ∈ \{ + , - , x , 〈 . , . 〉 , ( \begin{matrix}𝒥 \\ \end{matrix} ) , * \} \qquad ( 2 )$$

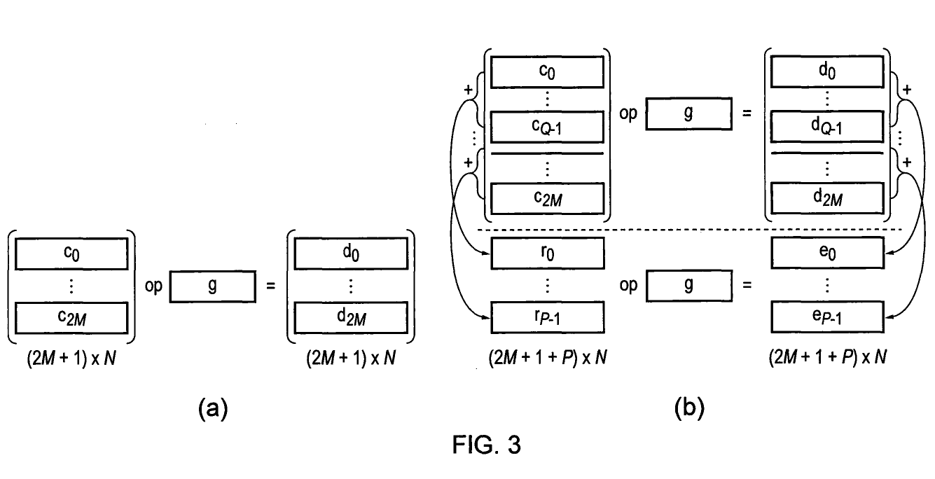

with dₘ being the m-th vector of output results and op being any LSB operator such as addition/subtraction, multiplication, inner product, permutation (bijective mapping from the sequential index set [symbol] to index set [symbol] corresponding to g) and circular convolution or cross-correlation with g. An illustration of the application of (2) is given in FIG. 3. If each input/output integer sample comprises w bits, the total number of possible fault patterns that may occur when a soft error happens in memory, arithmetic or logic operations is 2^{w}−1 faults per element. Beyond the single operation indicated in (2) and illustrated in FIG. 3(a) we can also assume a series of such operators applied consecutively in order to realise higher-level algorithmic processing, for example, multiple consecutive additions, subtractions and scaling operations with pre-established kernels followed by circular convolutions and permutation operations. Conversely, the input data streams can also be left in their native state (for example, stored in memory) if op={x} and g=1.

In their original (or “pure”) form, the input data streams of (1) are uncorrelated and one input element cannot be used to cross-check for faults in another without inserting some form of coding or redundancy. This is conventionally achieved in ABFT or ECC methods by creating P additional (redundant) inputs:

rₚ=[r_{p,0}, . . . ,r_{p,N-1}],0≦p<P (3)

by using, for example, the sum of groups of

$$Q = [ \frac{2 M + 1}{P} ]$$

input samples at position n in each stream, 0≦p<P, 0≦n<N:

$$Vp , n \text{:} {r}_{p , n} = {\sum }_{q = Qp}^{Q ( p + 1 ) - 1} {c}_{q , n} \qquad ( 4 )$$

The processing is then performed in all input streams cₘ and in all redundant input streams rₚ:

$$∀ m , p \text{:} [ \begin{matrix}{d}_{m} \\ {e}_{p}\end{matrix} ] = [ \begin{matrix}{c}_{m} \\ {r}_{p}\end{matrix} ] opg \qquad ( 5 )$$

Any single error in any group of Q outputs can then be detected by checking if:

$$∃ p , n \text{:} {\sum }_{q = Qp}^{Q ( p + 1 ) - 1} {d}_{q , n} \neq {e}_{p , n} \qquad ( 6 )$$

This process is pictorially illustrated in FIG. 3(b). If (6) holds, this means that outputs [d_{Qp,n}, . . . , d_{Q(p+1)-1,n}] contain an erroneous result. Evidently, decreasing the size of each group of inputs, Q, that are encoded together into one redundant stream increases the error detection capability. However, this comes at the cost of increasing the number of redundant input streams, P. For this reason, in practical ABFT or ECC approaches for fault detection in linear algebra systems [11][12][16], P ∈{(1,2,3}, such that only 1 to 3 redundant input streams are created and only 1 to 3 errors can be reliably detected within the groups of 2M+1 inputs with M≧50 [11] [12] [16]. At the other extreme, when P=2M+1 and Q=1, this results in repeating the operation twice (dual modular redundancy) and any errors on the original computation can be detected if the results are compared with the results of the redundant set and if the latter are assumed to be error free. In summary, the practical limitations of the ABFT and ECC approaches are:
1) The computation using the P redundant input streams requires the application of operator op for P additional times, which increases the implementation cost of the LSB operation (for example, processing cycles, energy consumption, memory accesses). Specifically, if P redundant input streams are generated for the entire set of inputs then the percentile implementation overhead is P %, which is labeled as low-redundant ECC/ABFT. If one redundant stream is generated for each 2M+1 input streams the percentile implementation overhead is

$$\frac{P}{2 M + 1} \times 100 \% ,$$

which is labeled as high-redundant ECC/ABFT.
2) The dynamic range of the computations with each of the redundant input streams is increased as each of the redundant input data values is the sum of groups of Q input samples as shown in (4).
3) The overall execution flow changes as the total number of input streams is changed from 2M+1 to 2M+1+P and the redundant input streams require additional storage or memory.

### Numerical Packing

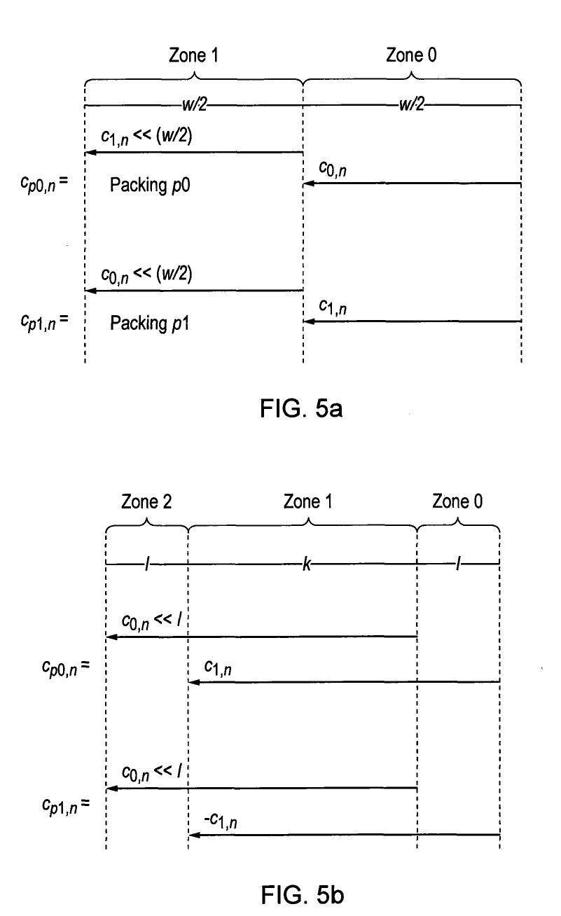

The present invention originated from previous work on packing approaches for pairs of integer inputs in order to provide accelerated approximate LBS operations [18]-[21]. The basic framework of such an approach is illustrated by FIG. 5a, where it is assumed that, for any n, c_{0,n} and c_{1,n} are non-negative. If c_{0,n} and c_{1,n} are signed integers then the sign information cannot be recovered reliably under integer numerical representation. Given that this case is introduced as prior art, this issue is not elaborated on further and it is assumed that all inputs are non-negative. However, the proposed entanglement process of the present invention assumes the general case of signed integers.

The horizontal arrows in FIG. 5a illustrate the dynamic range occupied by each number within the w-bit numerical representation of the two packed descriptions, c_{p0,n} and c_{p1,n}, which are given by (0≦n<N):

p_{0,n}=c_{0,n}+[c_{1,n}<<(w>>1)]

c_{p1,n}=[c_{0,n}<<(w>>1)]+c_{1,n} (7)

In this example, w∈{32, 64} for 32 or 64-bit integer representations. Within integer representations, multiplications with factors 2^{k}, k∈ [symbol] are performed via bit shifting by k positions, which is denoted by << and >> for k>0 and k<0, respectively.

Linear, sesquilinear or permutation operations can be performed on these inputs and then the final results can be recovered if the produced outputs do not have dynamic range exceeding

$$\frac{w}{2}$$

bits. Specifically, assuming that c_{p0,n} and c_{p1,n} contain the final results after any LSB processing, two copies of the outputs from Zones 0 and 1 can be recovered by (0≦n<N):

$${c}_{0 , r 0} = {ℳ}_{\frac{w}{2}} \{ {c}_{p 0 , n} \} \\ {c}_{0 , r 1} = [ {c}_{p 1 , n} ≫ ( w ≫ 1 ) ] \\ {c}_{1 , r 0} = [ {c}_{p 0 , n} ≫ ( w ≫ 1 ) ] \\ {c}_{1 , r 1} = {ℳ}_{\frac{w}{2}} \{ {c}_{p 1 , n} \} \qquad ( 8 )$$

With M_{b} {a} a binary ‘AND’ operator that retains the b least-significant bits of a and defined by:

[symbol]

b{a}=a[(1<<b)−1] (9)

The outputs may then be cross-validated by checking if c_{0,r0}≠c_{0,r1} or c_{1,r0}≠c_{1,r1} Evidently, this trivial case achieves detection of any faults occurring on either c_{p0,n} or c_{p1,n} but at the cost of decreasing the dynamic range to half the number of bits, that is from w bits to

$$\frac{w}{2}$$

bits per sample. Conversely, numerical packing can be seen as a form of dual modular redundancy where the utilized representation has twice the width (number of bits) needed to store the output results. Thus, under numerical packing, duplication is performed within the numerical representation of each input.

This non-overlapped packing can be extended to a case where the two numbers have a k-bit overlap zone within the packed representations, as shown in FIG. 5b and expressed analytically by the superpositions given, with the condition that k+2l=w, by (0≦n<N):

$${c}_{p 0 , n} = ( {c}_{0 , n} ≪ 𝓁 ) + {c}_{1 , n} \\ {c}_{p 1 , n} = ( {c}_{0 , n } ≪ 𝓁 ) - {c}_{1 , n} \qquad ( 10 )$$

Similarly as before, both inputs (or outputs produced after a series of LSB operations that ensure the dynamic range of each result stays within k+l bits) can be recovered by:

c_{0,n}=[(c_{p0,n}+C_{p1,n})>>(l+1)]

c_{1,n}=[(c_{p0,n}−c_{p1,n})>>1] (11)

Therefore, the part of c_{0,n} in Zone 2 and the part of c_{1,n} in Zone 0 can be cross-validated by:

$$\begin{matrix}{ℳ}_{𝓁} \{ {ℳ}_{𝓁} ( {c}_{p 0 , n} \} + {ℳ}_{𝓁} \{ {c}_{p 1 , n} \} \} \neq 0 & ( 12 ) \\ [ {c}_{p 0 , n} ≫ ( k + 𝓁 ) ] - [ {c}_{p 1 , n} ≫ ( k + 𝓁 ) ] \neq 0 & ( 13 )\end{matrix}$$

This indicates that guaranteed error detection is offered on all of the input or output samples of one packing if these errors happen within Zone 2 or Zone 0, which are non-overlapping zones. That is, for any n, 0≦n<N, guaranteed detection to 2l bits of c_{p0,n} and c_{p1,n} (or l bits of c_{0,n} and c_{1,n}) is provided, but detection cannot be guaranteed for the k bits that overlap. This detection capability comes with a loss of l bits of dynamic range and no external parity results are used. By setting k=0,

$$𝓁 = \frac{w}{2} ,$$

this case becomes the numerical packing case of (7), shown in FIG. 5a.

Despite the fact that (10) is a simple extension of the non-overlapped case, it offers two interesting insights: (i) sacrificing l bits from the numerical representation leads to detection of faults in 2l bits of c_{p0,n} and c_{p1,n}, as long as complementary faults do not happen on both of them; (ii) fault checking is done solely by matching information of one description with information of another.

The first point indicates that the superposition of (10) offers the same detection capability as an l-bit parity check or ECC scheme created for an l-bit zone of the inputs c_{0,n} and c_{1,n}, where up to l errors could be detected. However, unlike parity and ECC schemes, (10) does not require specialized hardware for encoding and decoding of each input. Beyond this, parity or ECC schemes would not be homomorphic to linear or sesquilinear operations, while the presented scheme is homomorphic to such operations.

The second point indicates that the form of superposition of (10) cannot lead to fault detection on the region of k bits that are left unprotected (Zone 1 of FIG. 5b) as there is no external parity information for them. Hence, even a single bit error in this region can remain undetected.

Numerical Entanglement

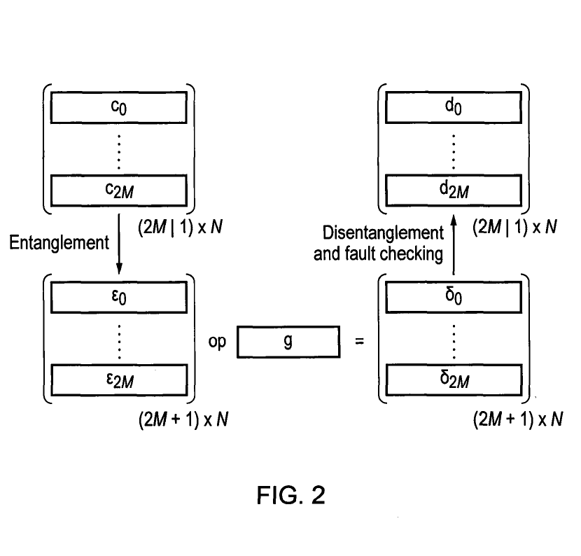

Numerical entanglement increases the fault detection capabilities of Numerical Packing, and can lead to detection of any fault occurring in one out of 2M+1 representations created. Moreover, numerical entanglement deals with the general case of signed integer outputs. In the present invention, numerical entanglement mixes the inputs prior to linear processing using linear superposition and ensures the results can be extracted and validated via a mixture of shift-add operations and bit-masking. As shown by FIG. 2, 2M+1 input streams (comprising N integer samples each and denoted by cₘ, 0≦m<2M+1) become 2M+1 entangled streams of integers (of N integer samples each), εₘ. Specifically, two input data streams are mixed together to form each entanglement. That is to say, two input data streams are mixed together to form one input stream, whereby one input stream is shifted by a specified amount, in this case l-bits, the shifted resulted being added to the other input data stream. Each element of the m-th entangled stream, ε_{m,n} (0≦n<N), comprises the partial superposition of two input elements c_{x,n} and c_{y,n} from different input streams x and y, such that 0≦x, y<2M+1 and x≠y. An LSB operation may then be carried out with the entangled input streams, thereby producing the entangled output data streams δₘ. These can be disentangled to extract the final output results dₘ via a disentanglement process that comprises a plurality of shift-add and bit-masking operations. Any faults or errors that may have occurred on any single entangled output stream within the 2M+1 representation are detectable with a simple fault-checking test that utilises a series of further additions, shift operations and bit masking.

Numerical Entanglement General Case (M≧1)

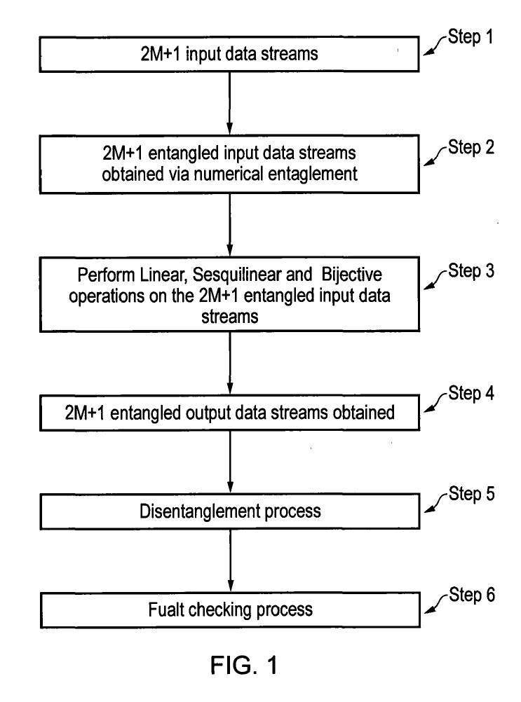

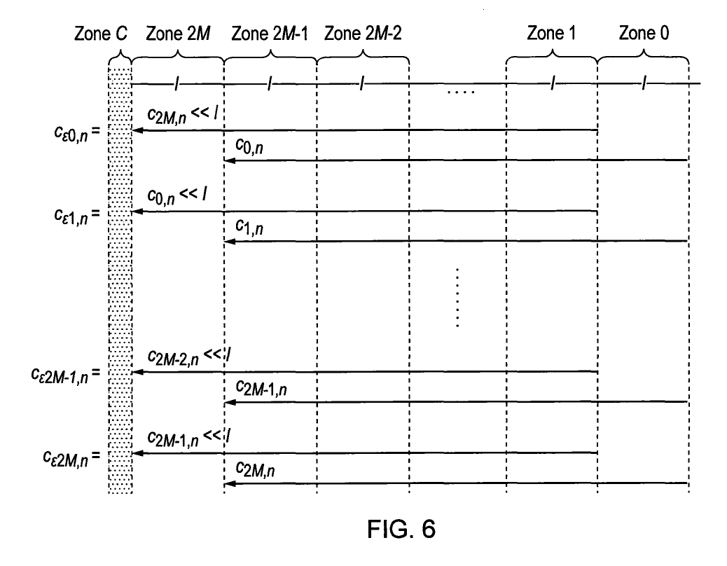

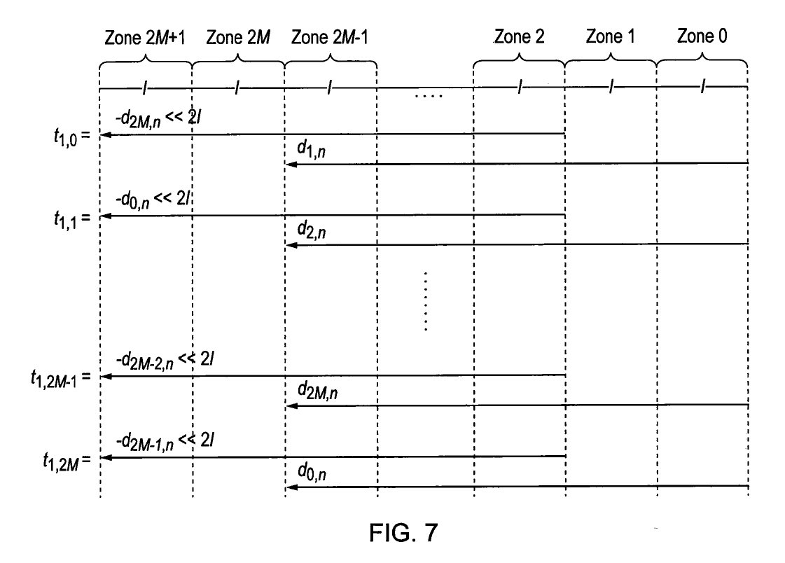

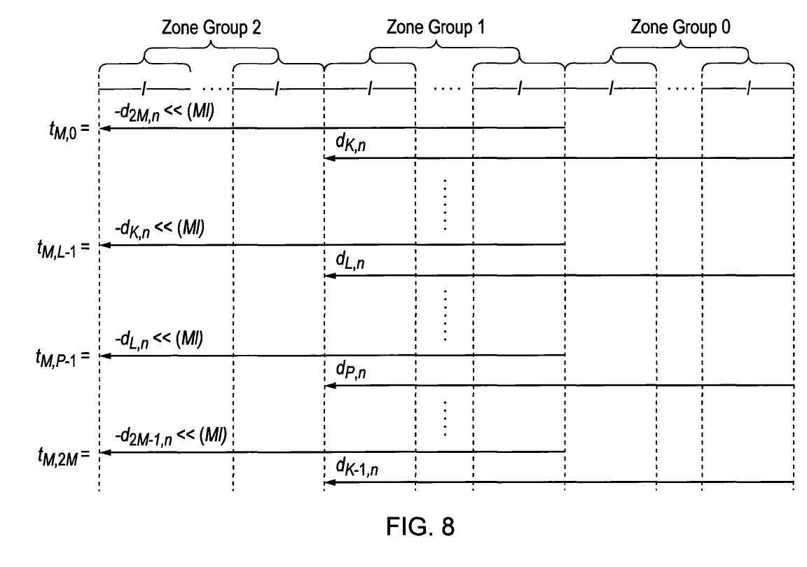

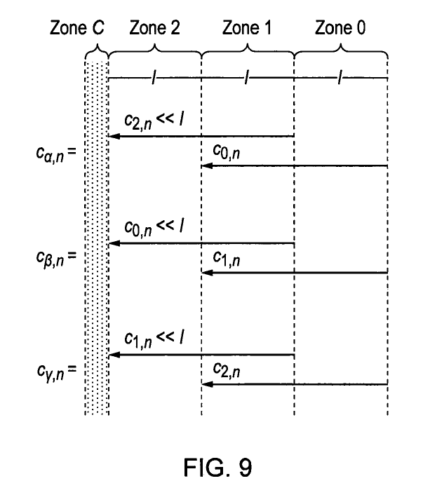

The present invention, as illustrated by FIG. 1, provides a method of fault detection in a plurality of data streams. Specifically, fault detection of 2M+1 input data streams comprising N integer samples.
Step 1 & 2: 2M+1 input data streams, c_{0,n}, . . . , c_{2M,n}, are mixed together via a process of numerical entanglement to create 2M+1 entangled input data streams, c_{ε0,n}, . . . , c_{ε2M,n}. FIG. 6 illustrates the entangled representation of the generalised case, wherein a w-bit entangled representation comprises 2M+1 numerical regions (zones) and, wherein each zone has a dynamic range of l-bits. For example, as shown in FIG. 9, in a 32-bit representation (w=32) with three input data streams (M=1), the entangled representation includes a Zone 0, Zone 1 and a Zone 2, each with a dynamic range of ten bits (l=10). This leaves two bits in a Zone C; one bit corresponding to the sign of the entangled input data streams and a second, unused bit.
   The process of numerical entanglement is essentially a linear superposition of two input data streams. To numerically entangle data streams, two input data streams are mixed together to form one input data stream. The resulting entangled input data stream has the overall effect of numerically representing both of the two input data streams. To begin the entanglement process, a first input data stream undergoes an arithmetic left shift by l-bits. The resulting shifted data stream is then added to a second input data stream to produce a third input data stream. This third input data stream is the entangled input data stream, and is contained within all 2M+1 zones of the numerical representation. For example, in the case of three input data streams, each entangled input data stream is contained within Zones 0 to 2, as shown by FIG. 9.
Step 3 & 4: Once the 2M+1 entangled input data streams have been produced, the 2M+1 entangled input data streams may undergo some form of data processing. In particular, linear, sesquilinear or bijective (LSB) operations may be performed on the 2M+1 entangled input data streams. As a result, 2M+1 entangled output data streams (d_{0,n}, . . . , d_{2M,n}) are produced. These 2M+1 entangled output data streams are such that, for every n, (0≦n<N), any single error or fault that may have occurred during the data processing can be detected within each 2M+1 entangled output data stream.
Step 5: The 2M+1 entangled output data streams then undergo a disentanglement process in order to extract the final output results of the data processing. The 2M+1 disentangled output data streams are such that they correspond to the outputs that would be obtained if the data processing was applied directly to the 2M+1 input data streams (c_{0,n}, . . . , c_{2M,n}) without the entanglement and disentanglement processes. In this way, the entanglement and disentanglement processes have no effect on the final result, and serves only to detect any faults or errors in the data processing.
   The disentanglement process utilises a series of shift-add operations and bit-masking. In particular, the operation [symbol] _{b}{a} of (9) serves as the primary operation used for the disentanglement process. This operator acts to retain the b least-significant (right-most) bits of a. It is noted that in a floating-point representation, this operation would be implemented by the modulo operator. In order to begin the disentanglement process, a first intermediate value must be produced.
   By way of example, consider the case of three entangled output data streams, d_{α,n}, d_{β,n} and d_{γ,n}. The entangled representation of these entangled output data streams is analogous to that of FIG. 9 as the entangled output streams have the same ordering as the entangled input data streams. Intermediate value t_{d0} is obtained by first left-shifting the bits contained within Zone 0 of d_{γ,n} (l least-significant bits of d_{γ,n}) by l-bits and subtracting the resulting data stream from the bits contained within Zone 0 and Zone 1 of d_{α,n} (2 l least-significant bits of d_{α,n}). The 2 l least-significant bits of the resulting data stream are then retained to produce the final t_{d0} data stream. The disentangled output data streams may then be produced.
   The first disentanglement is conducted by first left-shifting t_{d0} by l-bits and then retaining the 3 l least-significant bits of the shifted t_{d0} (basically retaining the bits contained within Zones 2, 1 and 0 of the shifted t_{d0}). The resulting data stream is then subtracted from the 3 l least-significant bits (the bits contained in Zones 2, 1 and 0) of one of the entangled output data streams, namely, an entangled output data stream not used to produce the intermediate value, for example, d_{β,n}. The resulting output data stream is the first disentangled output data stream, \hat{d}_{1,n}.
   To produce the final disentangled output data stream, the above process is again repeated. This time \hat{d}_{2,n} is left-shifted by l-bits and the 3 l least-significant bits of the shifted \hat{d}_{2,n} are retained (basically retaining the bits contained within Zones 2, 1 and 0 of the shifted \hat{d}_{2,n}). The resulting data stream is then subtracted from the 3 l least-significant bits (the bits contained in Zones 2, 1 and 0) of the next entangled output data streams, in this case, d_{α,n}. The resulting output data stream is the final disentangled output data stream, \hat{d}_{0,n}. It should be appreciated that this process may be repeated for 2M+1 entanglements for any M≧1 until each entangled output data stream has been disentangled.
   Additionally, M intermediate steps may be required in order for the entangled output data streams to be processed in a form where each section (specifically bottom, middle and top) can be checked for an error. For 2M+1 entanglements, the first intermediate step, as shown in FIG. 7, reproduces another 2M+1 entanglements, wherein each number within the description is offset by 2l bits. This may be repeated for M steps until the offset difference between the entangled outputs is Ml bits, thus providing Ml-bit overlapping. Once all M intermediate steps have been completed, intermediate values produced during the M intermediate steps are used to disentangle the entangled output data streams as described above.
   FIG. 8 illustrates the final intermediate step for 2M+1 entanglements. It can be seen that the bottom M zones (collectively presented as Zone Group 0 in FIG. 8) and top M zones (collectively presented as Zone Group 2 in FIG. 8) are clean, such that there is no overlapping of entangled outputs in these zones. Between these zones there are M zones of overlapping which are collectively presented as Zone Group 1 in FIG. 8. From this arrangement, the top, middle and bottom parts of each entangled output data stream may be checked to verify that the produced outputs are valid and that no errors have occurred.
Step 6: Once the output data streams have been disentangled, a fault checking process is conducted to validate the final disentangled output data streams against the entangled representation. This is done by implementing a series of further shift-add and bit-masking operation, based again on the binary ‘AND’ operation M_{b}{a} of (9). Each of the M zones that are checked comes from a different entangled output data stream such that, for every n (0≦n<N), an error occurring within 1 out of 2M+1 outputs may be detected. For example, in FIG. 8, the bottom zones of d_{K,n} (from intermediate value t_{M,0}) is matched with the top zones of d_{L,n} (from intermediate value t_{M,P-1}) and then validated against the middle zones of intermediate value t_{M,L-1}. In total, 4M+3 checks are required to sufficiently validate the disentangled output data streams against any error occurring within one out of 2M+1 entangled output data streams. That is 2M+1 checks for reconstructed entanglements, 2M+1 zonal checks within the outputs of FIG. 8 and one final check for all the combined zones. These checks will be described in more detail below.

It has been assumed that the dynamic range of the utilised representation (w bits) suffices for the storage of all intermediate results. If this is not the case in a practical hardware design, the operations can be separated into two or more registers of w-bit range. However, it is important to note that an increase in dynamic range does not mean that the entire process cannot take place within w-bit integer arithmetic units.

### Example 1—Numerical Entanglement in Groups of Three Inputs (M=1)

In one embodiment of the present invention, the method of fault detection is applied to three input integer data streams, c_{0,n}, c_{1,n} and c_{2,n}, i.e. M=1. The three input data streams, whereby 0≦n<N and N is the total number of integer input samples, are used to produce three entangled input data streams c_{α,n}, c_{β,n} and c_{γ,n}, as shown by FIG. 9. This is achieved via linear superposition of the 2M+1 input data streams wherein each input data stream is left-shifted by l-bits of dynamic range and added to another of the input data streams to form an entangled triplet:

c_{α,n}=(c_{2,n}<<l)+c_{0,n}

c_{β,n}=(c_{0,n}<<l)+c_{1,n}

c_{γ,n}=(c_{1,n}<<l)+c_{2,n} (14)

That is to say, two input data streams are mixed together to form a single data stream that numerically represents the two input data streams. In order to achieve the detection of any faults occurring in the 2M+1 entangled input data streams, l-bits of dynamic range is sacrificed and it is assumed that the dynamic range of the entangled representation, as shown in FIG. 9, never overflows. Basically, the dynamic range is contained within the three zones illustrated by FIG. 9, namely, Zone 0, Zone 1 and Zone 2. In this embodiment, there are w integer bits of data which may be more than or equal to 3 l. For the purposes of this example, consider a signed 32-bit integer configuration wherein w=32 and l=10 with two unused bits remaining; one for the sign of each entangled data stream and one unused bit, both contained in Zone C of FIG. 9. An LSB operation may then be performed on the 2M+1 entangled input data streams to produce 2M+1 entangled output data streams d_{α,n}, d_{β,n} and d_{γ,n}, which then undergo the disentanglement and fault checking process.

The bits in Zone C are unused and unprotected for all of the 2M+1 entangled output data streams, and so if the entangled results are signed, the disentanglement process begins by overwriting these unused bits with the most-significant bit of Zone 2 (i.e. the left-most bit, corresponding to bit 30 in the current example) in order to ensure the correct sign and bit representation is in place (an important feature for complement-two numerical representations). An intermediate value, t_{d0}, is then produced by means of a bit masking operation achieved by a series of binary AND operators, in order to mask the bits that are not of interest:

t_{d0}= [symbol] ₂ₗ{ [symbol] ₂ₗ{d_{α,n}}−( [symbol] ₗ{d_{γ,n}}<<l)} (15)

The bit-masking operator used is [symbol] _{b}{a}=a[(1<<b)−1] in which only the b least-significant (right-most) bits of a are retained. Intermediate value t_{d0} is obtained by first left-shifting the bits contained within Zone 0 of d_{γ,n} (l least-significant bits of d_{γ,n}) by l-bits and subtracting the resulting data stream from the bits contained within Zone 0 and Zone 1 of d_{α,n} (2 l least-significant bits of d_{α,n}). The 2 l least-significant bits of the resulting data stream are then retained to produce the final t_{d0} data stream. In doing this, parts of each entangled output data streams are concealed temporarily in order to extract specific parts of the data streams. This intermediate value, t_{d0}, is then subsequently used to produce disentangled output values \hat{d}_{0,n}, \hat{d}_{1,n} and \hat{d}_{2,n}. These disentangled output data streams are also achieved by bit masking via binary ‘AND’ operators. In this embodiment, disentangled output data streams \hat{d}_{1,n}, \hat{d}_{0,n}, \hat{d}_{2,n} are obtained by extracting the least-significant bits of entangled output data streams d_{β,n}, d_{α,n}, d_{γ,n}, respectively, and subtracting the least-significant bits of t_{d0}, \hat{d}_{α,n}, \hat{d}_{2,n}, respectively, which have been left-shifted a further l bits:

\hat{d}_{1,n}= [symbol] ₃ₗ{d_{β,n}}− [symbol] ₃ₗ{t_{d0}<<l}

\hat{d}_{2,n}= [symbol] ₃ₗ{d_{γ,n}}− [symbol] ₃ₗ{\hat{d}_{1,n}<<l}

\hat{d}_{0,n}= [symbol] ₃ₗ{d_{α,n}}− [symbol] ₃ₗ{\hat{d}_{2,n}<<l} (16)

The results may then be cross-checked for faults by checking the different numerical regions of the entanglement representation, as shown by FIG. 9, for each entanglement. In this embodiment, there are three checks comprising a further series of bit masking operations. If these checks hold for any n, wherein 0≦n<N, then a fault has occurred in one of the zones in one of the 2M+1 entanglements:

$$\begin{matrix}{ℳ}_{𝓁} \{ {ℳ}_{𝓁} \{ {d}_{α , n} \} + {ℳ}_{𝓁} \{ {d}_{γ , n} ≫ 2 𝓁 \} \} - {ℳ}_{𝓁} \{ {d}_{β , n} ≫ 𝓁 \} - [ ( {ℳ}_{𝓁} \{ {\hat{d}}_{2 , n} ≫ 𝓁 \} + {ℳ}_{𝓁} \{ {\hat{d}}_{1 , n} \} ) ≫ 𝓁 ] \neq 0 & ( 17 ) \\ {ℳ}_{𝓁} \{ {ℳ}_{𝓁} \{ {d}_{β , n} \} + {ℳ}_{𝓁} \{ {d}_{α , n} ≫ 2 𝓁 \} \} - {ℳ}_{𝓁} \{ {d}_{γ , n} ≫ 𝓁 \} - [ ( {ℳ}_{𝓁} ( {\hat{d}}_{0 , n} ≫ 𝓁 \} + {ℳ}_{𝓁} \{ {\hat{d}}_{2 , n} \} ) ≫ 𝓁 ] \neq 0 & ( 18 ) \\ {ℳ}_{𝓁} \{ {ℳ}_{𝓁} \{ {d}_{γ , n} \} + {ℳ}_{𝓁} \{ {d}_{β , n} ≫ 2 𝓁 \} \} - {ℳ}_{𝓁} \{ {d}_{α , n} ≫ 𝓁 \} - [ ( {ℳ}_{𝓁} \{ {\hat{d}}_{1 , n} ≫ 𝓁 \} + {ℳ}_{𝓁} \{ {\hat{d}}_{0 , n} \} ) ≫ 𝓁 ] \neq 0 & ( 19 )\end{matrix}$$

For example, if check (17) holds, then a fault has occurred in either Zone 0 of d_{α,n}, Zone 1 of d_{β,n} or Zone 2 of d_{γ,n}, with subsequent checks, (18) and (19), detecting any faults in the remaining zones for each entanglement. For unsigned bits with dynamic range d₀, d₁, d₂ ∈{0, . . . , 2^{2l}−2^{l}}, errors will only remain undetected if and only if they occur in more than one of d_{α,n}, d_{β,n} and d_{γ,n} and occur in a manner that none of the zone checks can detect. Therefore, for unsigned outputs, the zone checks (17)-(19) are sufficient for detection of any single error d_{α,n}, d_{β,n} and d_{γ,n} for all n, 0≦n<N.

However, if the integer outputs are signed integers, an additional set of extractions and checks are needed based on the signs of the disentangled outputs \hat{d}_{0,n}, \hat{d}_{1,n} and \hat{d}_{2,n}. The additional checks are designed to specifically detect cases of errors that would corrupt the sign bit and the entangled representations of d_{α,n}, d_{β,n}, and d_{γ,n} in a manner that (17)-(19) would not. As described above, the disentangled values are produced by obtaining an intermediate value, t_{d0}, and then conducting a series of bit masking operations. However, the case where t_{d0}, \hat{d}_{1,n} or \hat{d}_{2,n} may have a zero value is considered and an additional set of conditions are applied in the process.

(i) If t_{d0}=0, then \hat{d}_{1,n}=d_{β,n}; otherwise: \hat{d}_{1,n}= [symbol] ₃ₗ{d_{β,n}}− [symbol] −{t_{d0}<<l}.

(ii) If \hat{d}_{1,n}=0, then \hat{d}_{2,n}=d_{γ,n}; otherwise: \hat{d}_{2,n}= [symbol] ₃ₗ{d_{γ,n}}− [symbol] ₃ₗ{\hat{d}_{1,n}<<l}.

(iii) If \hat{d}_{2,n}=0, then \hat{d}_{0,n}=d_{α,n}; otherwise: \hat{d}_{0,n}= [symbol] ₃ₗ{d_{α,n}}− [symbol] ₃ₗ{\hat{d}_{2,n}<<l}.

From these disentangled values, entangled data streams are reproduced, \hat{d}_{α,n}, \hat{d}_{β,n} and \hat{d}_{γ,n}, via linear superposition of the disentangled values in a similar manner to the original entanglement of (14).

\hat{d}_{α,n}=(\hat{d}_{2,n}<<l)+\hat{d}_{0,n}

\hat{d}_{β,n}=(\hat{d}_{0,n}<<l)+\hat{d}_{1,n}

\hat{d}_{γ,n}=(\hat{d}_{1,n}<<l)+\hat{d}_{2,n} (20)

An additional set of values, z₁, z₂ and z₃ are then defined based on right-shift and bit masking operations using the disentangled outputs that have been obtained.

z₁=( [symbol] ₗ{\hat{d}_{2,n}>>l}+ [symbol] ₗ{\hat{d}_{1,n}})>>l

z₂=( [symbol] ₗ{\hat{d}_{0,n}>>l}+ [symbol] ₗ{\hat{d}_{2,n}})>>l

z₃=( [symbol] ₗ{\hat{d}_{1,n}>>l}+ [symbol] ₗ{\hat{d}_{0,n}})>>l (21)

The zₘ₊₁ (0≦m<3) values may be adjusted if the signs of the 2M+1 disentangled output data streams are negative via a series of further left-shift, bit masking and arithmetic operations.

(a) If \hat{d}_{2,n}<0, then z₁= [symbol] {(1<<l)−1+z₁}.

(b) If \hat{d}_{0,n}<0, then z₂= [symbol] ₗ{(1<<l)−1+z₂}.

(c) If \hat{d}_{1,n}<0, then z₃= [symbol] ₗ{(1<<l)−1+z₃}.

Finally, a set of seven checks, based on the original and reproduced entangled outputs, the bit-masking of entangled outputs d_{α,n}, d_{β,n} and d_{γ,n} and z₁, z₂ and z₃, are used to check for faults such that if any of the checks (22)-(28) hold for any n, then an error has occurred in one of the entanglements.

d_{α,n}≠\hat{d}_{α,n} (22)

d_{β,n}≠\hat{d}_{β,n} (23)

d_{γ,n}≠\hat{d}_{γ,n} (22)

[symbol]

ₗ{ [symbol] ₗ{d_{α,n}}+ [symbol] ₗ{d_{γ,n}>>2l}− [symbol] ₗ{(d_{β,n}>>l}−z₁}≠0 (25)

[symbol]

ₗ{ [symbol] ₗ{d_{β,n}}+ [symbol] ₗ{d_{α,n}>>2l}− [symbol] ₁{(d_{γ,n}>>l}−z₂}≠0 (26)

[symbol]

ₗ{ [symbol] ₗ{d_{γ,n}}+ [symbol] ₗ{d_{β,n}>>2l}− [symbol] ₁{(d_{α,n}>>l}−z₃}≠0 (27)

$${ℳ}_{𝓁} \{ {ℳ}_{𝓁} \{ {d}_{α , n} \} + {ℳ}_{𝓁} \{ {d}_{β , n} \} + {ℳ}_{𝓁} \{ {d}_{γ , n} \} + {ℳ}_{𝓁} \{ {d}_{γ , n} ≫ 2 𝓁 \} + {ℳ}_{𝓁} \{ {d}_{α , n} ≫ 2 𝓁 \} + {ℳ}_{𝓁} \{ {d}_{β , n} ≫ 2 𝓁 \} - {ℳ}_{𝓁} \{ {d}_{γ , n} ≫ 𝓁 \} - {ℳ}_{𝓁} \{ {d}_{β , n} ≫ 𝓁 \} - {ℳ}_{𝓁} \{ {d}_{α , n} ≫ 𝓁 \} - {z}_{1} - {z}_{2} - {z}_{3} \} \neq 0 \qquad ( 28 )$$

As before, the checks can detect the occurrence of error in each entanglement for different numerical regions. Specifically, if (25) holds, then an error occurred either in Zone 0 of d_{α,n} or in Zone 1 of d_{β,n} or in Zone 2 of d_{γ,n}. If (26) holds, then an error occurred either in Zone 0 of d_{β,n} or in Zone 1 of d_{γ,n} or in Zone 2 of d_{α,n}. If (27) holds, then an error occurred either in Zone 0 of d_{γ,n} or in Zone 1 of d_{α,n} or in Zone 2 of d_{β,n}. Finally, in a similar manner, if (22)-(24) or (28) hold, then an error occurred in the zones of d_{α,n}, d_{β,n} or d_{γ,n} corresponding to the dynamic range of the result of the check. Thus, for signed outputs, (22)-(28) are necessary and sufficient for the detection of any single error in d_{α,n}, d_{β,n}, d_{γ,n} foralln, 0≦n<N.

During the production of the results (or while the inputs themselves are stored in memory) a fault may have occurred in the unprotected Zone C in a way that makes the entangled results obtain the opposite sign. While this would have no effect in signed-digit representations, this will affect the entirety of the values of the results in complement-two numerical representations, which are used in most computer hardware. Hence, to protect the integrity of this zone, the maximum dynamic range of the final signed outputs is set to d₀, d₁, d₂ ∈{−(2^{2l-1}−2^{l}), . . . ,2^{2l-1}−2^{l}} so that the most-significant bit of the entangled (and protected) Zone 2 represents the correct sign bit of the entangled results. Since this bit is protected, all bits of Zone C are overwritten with it before starting the disentanglement and error checking process. This ensures the correct sign and the correct bit representation is in place for complement-two numerical representations.

### Example 2—Entanglement in Groups of Five Inputs (M=2)

In another embodiment of the present invention, the method of fault detection is applied to five input integer data streams, c_{0,n}, c_{1,n}, c_{2,n}, c_{3,n} and c_{4,n}, i.e. M=2. By extending the entanglement to five input integer data streams, the dynamic range of the entangled LSB processing is increased. As a result, for every n, whereby 0≦n<N and N is the total number of integer input samples within each entangled input data stream, any single error will be detected within every quintuple of the input and output samples. The five input data streams are used to produce five entangled input data streams C_{α,n}, c_{β,n}, c_{γ,n}, c_{δ,n} and c_{ε,n}, as illustrated in FIG. 10. This is achieved, as described previously, via linear superposition of the five input data streams wherein each input data stream is left-shifted by l-bits of dynamic range and added to another of the input data streams.

c_{α,n}=(c_{4,n}<<l)+c_{0,n}

c_{β,n}=(c_{0,n}<<l)+c_{1,n}

c_{γ,n}=(c_{1,n}<<l)+c_{2,n}

c_{δ,n}=(c_{2,n}<<l)+c_{3,n}

c_{ε,n}=(c_{3,n}<<l)+c_{4,n} (29)

In order to achieve the detection of any faults occurring in the 2M+1 entangled input data streams, l-bits of dynamic range is sacrificed and it is assumed that the dynamic range of the entangled representation, as illustrated in FIG. 10, never overflows. Basically, the dynamic range is contained within five zones of FIG. 10, namely, Zone 0, Zone 1, Zone 2, Zone 3 and Zone 4. As before, there are w integer bits of data within the numerical representation. For the purposes of this example, consider a signed 32-bit integer configuration wherein w=32 and l=6 with two unused bits remaining; one for the sign of each entangled data stream and one unused bit, both contained in Zone C of FIG. 10. An LSB operation may then be performed on the five entangled input data streams to produce five entangled output data streams d_{α,n}, d_{β,n}, d_{γ,n}, d_{δ,n} and d_{ε,n}, which then undergo the disentanglement and fault checking process.

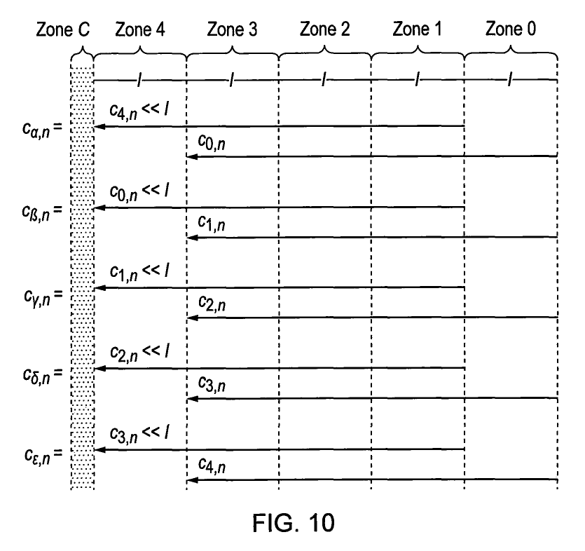

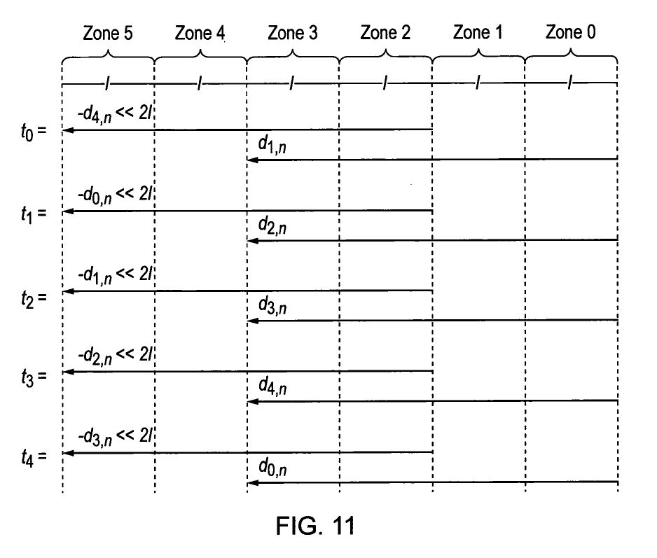

The bits in Zone C are unused and unprotected for all of the entangled output data streams, and so if the entangled outputs are signed, the disentanglement process begins by overwriting these unused bits with the most-significant bit of Zone 4 (corresponding to bit 30 in the current example) in order to ensure the correct sign and bit representation is in place (important for complement-two numerical representations). Five intermediate values t₀, t₁, t₂, t₃ and t₄, as shown in FIG. 11, are first produced by left-shifting the entangled output data streams by l-bits and then subtracting the left-shifted values from one of the other entangled output data streams.

t₀=d_{β,n}−(d_{α,n}<<l)

t₁=d_{γ,n}−(d_{β,n}<<l)

t₂=d_{δ,n}−(d_{γ,n}<<l)

t₃=d_{ε,n}−(d_{δ,n}<<l)

t₄=d_{α,n}−(d_{ε,n}<<l) (30)

Due to the increase in dynamic range, it may be a possibility that certain parts of the disentanglement and fault-checking process will need to be separated into two or more operands of w bits. However, this case will not be considered here as the increase in dynamic range does not mean the entire process cannot take place within the w-bit integer arithmetic units.

To begin the disentanglement, an intermediate value, t_{d1}, is then produced by means of a bit masking operation achieved by a series of binary ‘AND’ operators.

t_{d1}= [symbol] ₄ₗ{t₀−( [symbol] ₂ₗ{t₃}<<2l)} (31)

This intermediate value, t_{d1}, is then subsequently used to produce five disentangled output data streams \hat{d}_{0,n}, \hat{d}_{1,n}, \hat{d}_{2,n}, \hat{d}_{3,n} and \hat{d}_{4,n}. These disentangled output data streams are achieved, as described previously, by bit masking via a series of binary ‘AND’ operators, along with a set of conditions with regards to the possibility that any of t_{d1}, \hat{d}_{0,n}, \hat{d}_{2,n}, \hat{d}_{3,n} or \hat{d}_{4,n} may have a zero value.

(i) If t_{d1}=0, then \hat{d}_{3,n}=t₄; otherwise: \hat{d}_{3,n}= [symbol] ₄ₗ{t₂}+ [symbol] ₄ₗ{td₁<<2l}.

(ii) If \hat{d}_{3,n}=0, then \hat{d}_{0,n}=t₄; otherwise: \hat{d}_{0,n}= [symbol] ₄ₗ{t₄}+ [symbol] ₄ₗ{\hat{d}_{3,n}<<2l}.

(iii) If \hat{d}_{0,n}=0, then \hat{d}_{2,n}=t₁; otherwise: \hat{d}_{2,n}= [symbol] ₄ₗ{t₁}+ [symbol] ₄ₗ{\hat{d}_{0,n}<<2l}.

(iv) If \hat{d}_{2,n}=0, then \hat{d}_{4,n}=t₃; otherwise: \hat{d}_{4,n}= [symbol] ₄ₗ{t₃}+ [symbol] ₄ₗ{\hat{d}_{2,n}<<2l}.

(v) If \hat{d}_{4,n}=0, then \hat{d}_{1,n}=t₀; otherwise: \hat{d}_{1,n}= [symbol] ₄ₗ{t₀}+ [symbol] ₄ₗ{\hat{d}_{4,n}<<2l}.

From these disentangled values, entangled data streams, \hat{d}_{α,n}, \hat{d}_{β,n}, \hat{d}_{γ,n}, \hat{d}_{δ,n} and \hat{d}_{ε,n}, are reproduced via linear superposition of the disentangled values in a similar manner to that of the original entanglement.

\hat{d}_{α,n}=(\hat{d}_{4,n}<<l)+\hat{d}_{0,n}

\hat{d}_{β,n}=(\hat{d}_{0,n}<<l)+\hat{d}_{1,n}

\hat{d}_{γ,n}=(\hat{d}_{1,n}<<l)+\hat{d}_{2,n}

\hat{d}_{δ,n}=(\hat{d}_{2,n}<<l)+\hat{d}_{3,n}

\hat{d}_{ε,n}=(\hat{d}_{3,n}<<l)+\hat{d}_{4,n} (32)

An additional set of values, z₁, z₂, z₃, z₄ and z₅ are then defined based on right-shift and bit masking operations using the disentangled outputs that have been obtained.

z₁= [symbol] ₂ₗ{\hat{d}_{0,n}>>2l}+ [symbol] ₂ₗ{−\hat{d}_{3,n}})>>2l

z₂= [symbol] ₂ₗ{\hat{d}_{1,n}>>2l}+ [symbol] ₂ₗ{−\hat{d}_{4,n}})>>2l

z₃= [symbol] ₂ₗ{\hat{d}_{2,n}>>2l}+ [symbol] ₂ₗ{ [symbol] _{0,n}})>>2l

z₄= [symbol] ₂ₗ{\hat{d}_{3,n}>>2l}+ [symbol] ₂ₗ{−\hat{d}_{1,n}})>>2l

z₅= [symbol] ₂ₗ{\hat{d}_{4,n}>>2l}+ [symbol] ₂ₗ{ [symbol] _{2,n}})>>2l (33)

These values may be adjusted if the signs of the disentangled outputs are negative via a series of further left-shift, bit masking and arithmetic operations.

(a) If \hat{d}_{0,n}<0, then z₁= [symbol] ₂ₗ{(1<<2l)−1+z₁}.

(b) If \hat{d}_{1,n}<0, then z₂= [symbol] ₂ₗ{(1<<2l)−1+z₂}.

(c) If \hat{d}_{2,n}<0, then z₃= [symbol] ₂ₗ{(1<<2l)−1+z₃}.

(d) If \hat{d}_{3,n}<0, then z₄= [symbol] ₂ₗ{(1<<2l)−1+z₄}.

(e) If \hat{d}_{4,n}<0, then z₅= [symbol] ₂ₗ{(1<<2l)−1+z₅}.

Finally, a set of eleven checks, based on the original and reproduced entangled outputs, intermediate values t₀, t₁, t₂, t₃ and t₄ and z₁, z₂, z₃, z₄ and z₅, are used to check for faults.

d_{α,n}≠\hat{d}_{α,n} (34)

d_{β,n}≠\hat{d}_{β,n} (35)

d_{γ,n}≠\hat{d}_{γ,n} (36)

d_{δ,n}≠\hat{d}_{δ,n} (37)

d_{ε,n}≠\hat{d}_{ε,n} (38)

[symbol]

₂ₗ{ [symbol] ₂ₗ{t₀}+ [symbol] ₂ₗ{t₄>>4l}− [symbol] ₂ₗ{−t₂>>2l}−z₁}≠0 (39)

[symbol]

₂ₗ{ [symbol] ₂ₗ{t₁}+ [symbol] ₂ₗ{t₀>>4l}− [symbol] ₂ₗ{−t₃>>2l}−z₂}≠0 (40)

[symbol]

₂ₗ{ [symbol] ₂ₗ{t₂}+ [symbol] ₂ₗ{t₁>>4l}− [symbol] ₂ₗ{−t₄>>2l}−z₃}≠0 (41)

[symbol]

₂ₗ{ [symbol] ₂ₗ{t₃}+ [symbol] ₂ₗ{t₂>>4l}− [symbol] ₂ₗ{−t₀>>2l}−z₄}≠0 (42)

[symbol]

₂ₗ{ [symbol] ₂ₗ{t₄}+ [symbol] ₂ₗ{t₃>>4l}− [symbol] ₂ₗ{−t₁>>2l}−z₅}≠0 (43)

$${ℳ}_{2 𝓁} \{ {ℳ}_{2 𝓁} \{ {t}_{0} \} + {ℳ}_{2 𝓁} \{ {t}_{1} \} + {ℳ}_{2 𝓁} \{ {t}_{2} \} + {ℳ}_{2 𝓁} \{ {t}_{3} \} + {ℳ}_{2 𝓁} \{ {t}_{4} \} + {ℳ}_{2 𝓁} \{ {t}_{0} ≫ 4 𝓁 \} + {ℳ}_{2 𝓁} \{ {t}_{1} ≫ 4 𝓁 \} + {ℳ}_{2 𝓁} \{ {t}_{2} ≫ 4 𝓁 \} + {ℳ}_{2 𝓁} \{ {t}_{3} ≫ 4 𝓁 \} + {ℳ}_{2 𝓁} \{ {t}_{4} ≫ 4 𝓁 \} - {ℳ}_{2 𝓁} \{ - {t}_{0} ≫ 2 𝓁 \} - {ℳ}_{2 𝓁} \{ - {t}_{1} ≫ 2 𝓁 \} - {ℳ}_{2 𝓁} \{ - {t}_{2} ≫ 2 𝓁 \} - {ℳ}_{2 𝓁} \{ - {t}_{3} ≫ 2 𝓁 \} - {ℳ}_{2 𝓁} \{ - {t}_{4} ≫ 2 𝓁 \} - {z}_{1} - {z}_{2} - {z}_{3} - {z}_{4} - {z}_{5} \} \neq 0 \qquad ( 44 )$$

If any of the checks (34)-(44) hold for any n, then an error has occurred in one of the five entanglements. As before, the checks can detect the occurrence of error in each entanglement for different numerical regions.

Applications of the Present Invention

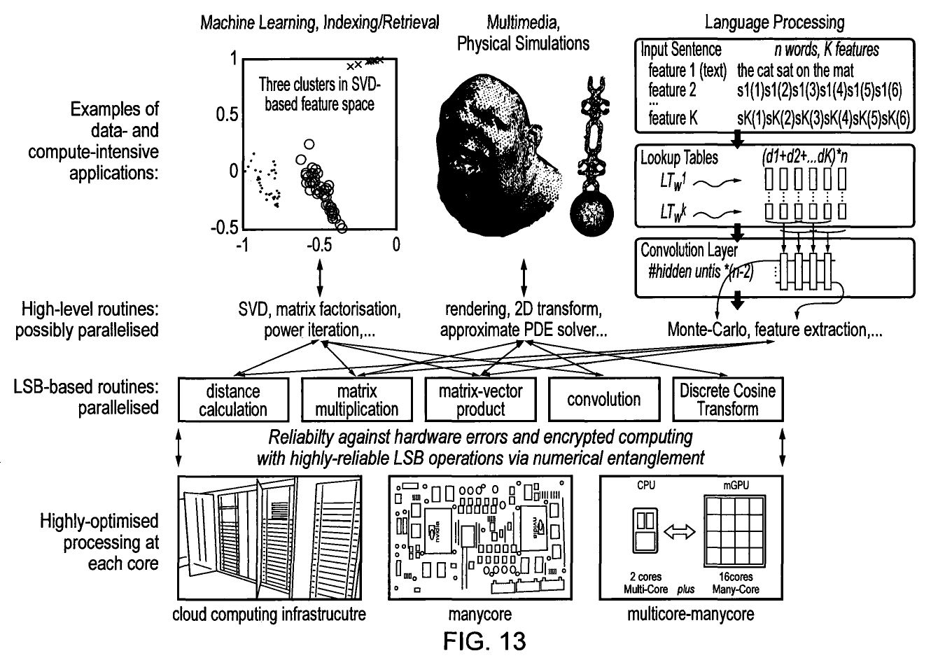

LSB (linear, sesquilinear and bijective) operations comprise, for example, matrix products, template matching, transform decompositions, element-by-element additions and multiplications, sum-of-products, sum-of-squares and permutation operations. Their usage within three application clusters forming the foundation of much of today's information and communications technology is illustrated by FIG. 13 and outlined below.

(i) Information Indexing and Retrieval.
In this cluster, the dominant computation kernels include, for example, matrix and vector products, calculation of principal eigenvectors of document adjacency matrices, approximate singular value decomposition (SVD) calculations, template (or string) matching, distance metric calculations. Examples of applications of such computations include image, video, music, or metadata-based retrieval based on similarity to a given input, and top-K query processing for web search engine services.

(ii) Error-Tolerant Data Analysis and Reconstruction.
These are applications that make heavy use of matrix products, matrix-vector products, convolution and transform decompositions. Examples of such applications include graphics rendering and animation, salient-point extraction in images, super-resolution and 3D reconstruction from multiple views, approximations of partial differential equations (PDEs) in large simulations of dynamic systems, and Black-Scholes models in financial options analysis.

(iii) Computationally-Intensive Learning and Recognition Tasks.
Resource-intensive operations of this category include, for example, matrix products and matrix-vector products, distance metric calculations, iterative SVD & linear solvers. Examples of applications of such operations include deep neural networks for natural language processing, cluster hierarchy formation and categorization of huge text corpora, and Monte-Carlo methods, structural and statistical analysis of election data, medical data (for example, DNA sequencing) for anomaly discovery.

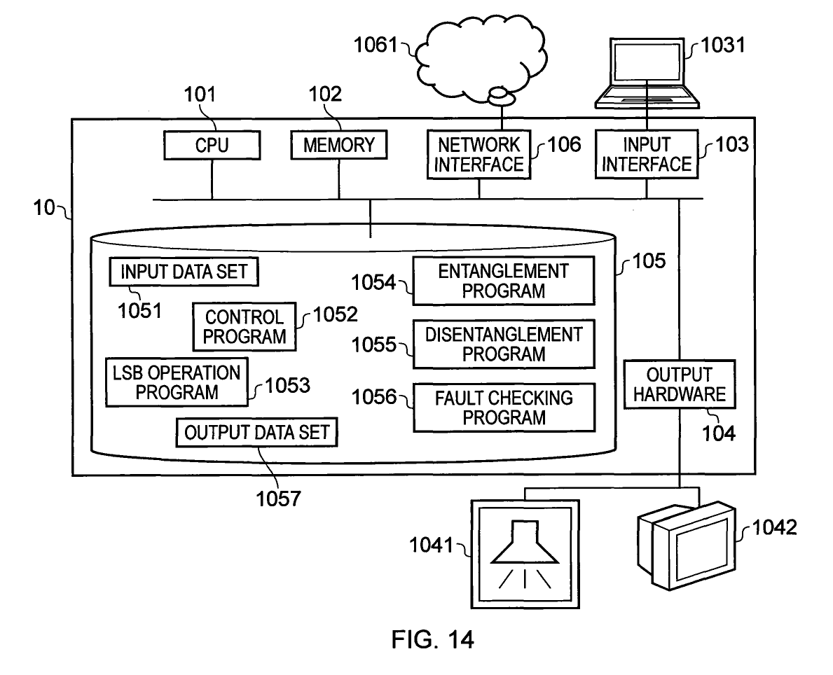

FIG. 14 illustrates an example of a general computer system 10 that may form the platform for embodiments of the invention. The computer system 10 comprises a central processing unit (CPU) 101, a working memory 102, an input interface 103 arranged to receive control inputs from a user via an input device 1031 such as a keyboard, mouse, or other controller, and output hardware 104 arranged to provide output information to a user. The output hardware 104 may include a visual display unit 1042, speaker 1041 or any other device capable of presenting information to a user. Additionally, the computer system 10 may optionally be connected to a network interface 106 to provide connectivity to a network 1061 such as a cloud infrastructure provided by a third party.

The computer system 10 is also provided with a computer readable storage medium 105 such as a hard disk drive (HDD), flash drive, solid state drive, or any other form of general purpose data storage, upon which stored data 1051, 1057 and various control programs are arranged to control the computer system 10 to operate in accordance with embodiments of the present invention. For example, an overall control program 1052 is provided, which is arranged to provide overall control of the system to perform embodiments of the invention, for example, including receiving user inputs as to which data should be processed, and launching other programs to perform specific data processing tasks. There is also provided an entanglement program 1054 which is arranged to numerically entangle data from the input data set 1051 under the control of the control program 1052. An LSB operation program 1053 is also provided, which performs LSB operations on entangled input data to produce entangled output data, under the control of the control program 1052. A disentanglement program 1055 is further provided, which is arranged to disentangle data, again under the control of the control program 1052. Finally, a fault checking program 1056 is provided, that acts to detect faults in disentangled output data, under the control of the control program 1052, as before.

In addition to the above, the computer readable medium 104 also stores thereon respective output data sets 1057, representing the output data or other data relating to the results of the fault checking process in accordance with embodiments of the invention.

It should be appreciated that various other components and systems would of course be known to the person skilled in the art to permit the computer system 10 to operate.

### Example Application 1: Encrypted Computing or Computing with Obfuscated Data

A further application of the embodiments of the invention is in encrypted computing or computing with obfuscated data. The inherent obfuscation property of the present invention resulting from the process of numerical entanglement provides inherent resistance to tampering within any single entangled description and provides a practical avenue for encrypted computing of LSB operations. Encrypted computing may be employed in a variety of practical applications, for example, text based query processing, multimedia matching and retrieval, template matching via cross-correlation, integer transform decomposition, filtering and averaging for sensitive data aggregation.

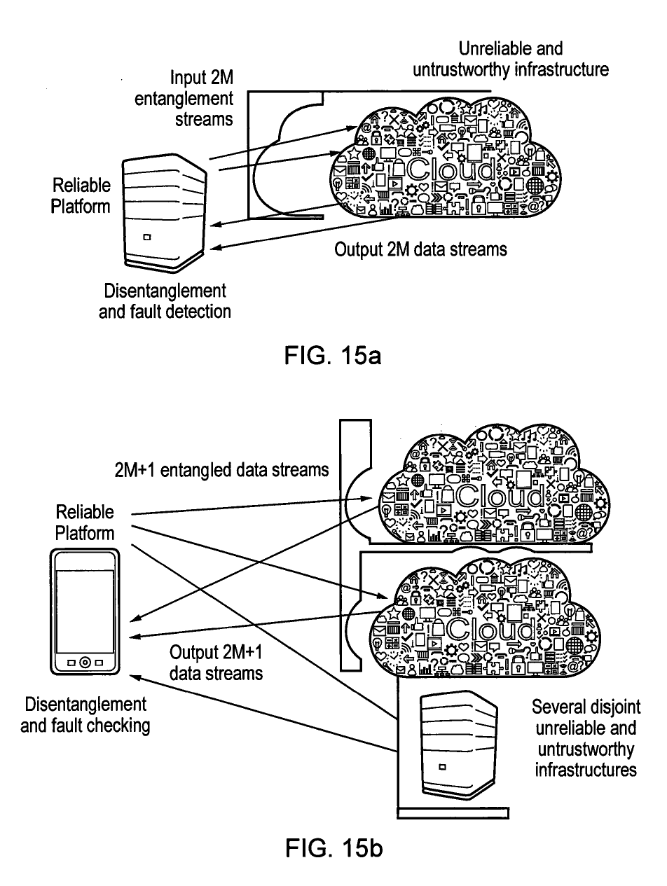

A computer system 10, as illustrated by FIG. 14, is capable of computing LSB operations on 2M+1 integer data streams in an unbreakable encrypted form. A user may provide control inputs via the input device 1031 instructing the computer system 10 to process the 2M+1 data streams. The computer system 10 may comprise a readable storage medium 105 including an overall control program 1052 arranged to provide overall control of the system. The control program 1052 then receives the user inputs, and launches an entanglement program 1054 which is arranged to numerically entangle the 2M+1 data streams. The entanglement program 1054 performs the entanglement process by mixing pairs of input data streams according to a set of entanglement parameters, wherein the entanglement parameters are kept private and are known only to the computer system 10. The computer system 10 may then send 2M entangled data streams, as shown in FIG. 15a, to be processed in an unreliable and untrustworthy network 1061 such as a cloud computing environment, whilst retaining one entangled data stream to be processed in a reliable and trustworthy platform. For example, the retained entangled data stream may be processed by a LSB operation program 1053 within the computer system 10.

The computer system 10 then retrieves the 2M entangled output results from the network 1061. To ensure that the data has not been tampered with, either by a faulty operation or via a malicious attack to corrupt the inputs or outputs, post-computation reliability checks may be performed in the reliable platform. For example, these checks may be performed by fault checking program 1056. However, it should be appreciated that the disentanglement and fault checking process may be performed in any reliable and trustworthy platform. Moreover, given that the untrustworthy infrastructure 1061 of the cloud computing cannot gain access to all 2M+1 entangled data streams, it is mathematically guaranteed that the original input data or the final output results cannot be recovered by an attacker that has no access to the entanglement parameters. That is to say, if the attacker does not have access to all 2M+1 data streams, it is impossible to obtain the disentangled output results, regardless of the amount of computational effort that is available.

Alternatively, the computer system 10 may send all 2M+1 entangled input data streams to the unreliable and untrustworthy cloud environment 1061. Since the entanglement parameters are kept private, this provides for high obfuscation and encryption capability for M≧14. As will be described in more detail below, this is because 2vM(2M+1)! operations are required to recover the original input data or the final output results from their entangled form, wherein v∈{2,4,8}.

Furthermore, as shown in FIG. 15b, a reliable mobile platform may send the input entangled data streams to multiple disjoint computing infrastructures with the post computation disentanglement and fault detection being performed in the reliable mobile platform.

### Example Application 2: Dynamic Voltage and Frequency Over-Scaling in Integer LSB Computations

It is well known that static and dynamic power consumption in an integrated circuit are proportional to the cube and the square of the supply voltage, respectively. Similarly, substantial energy savings can be obtained by increasing the processor frequency as the final results are produced faster, which allows for more power-downs for the utilized hardware (longer periods of inactivity at minimum or no energy expenditure for the system). For these reasons, power-aware embedded or high-performance computing systems today use dynamic voltage and frequency scaling to reduce energy consumption.

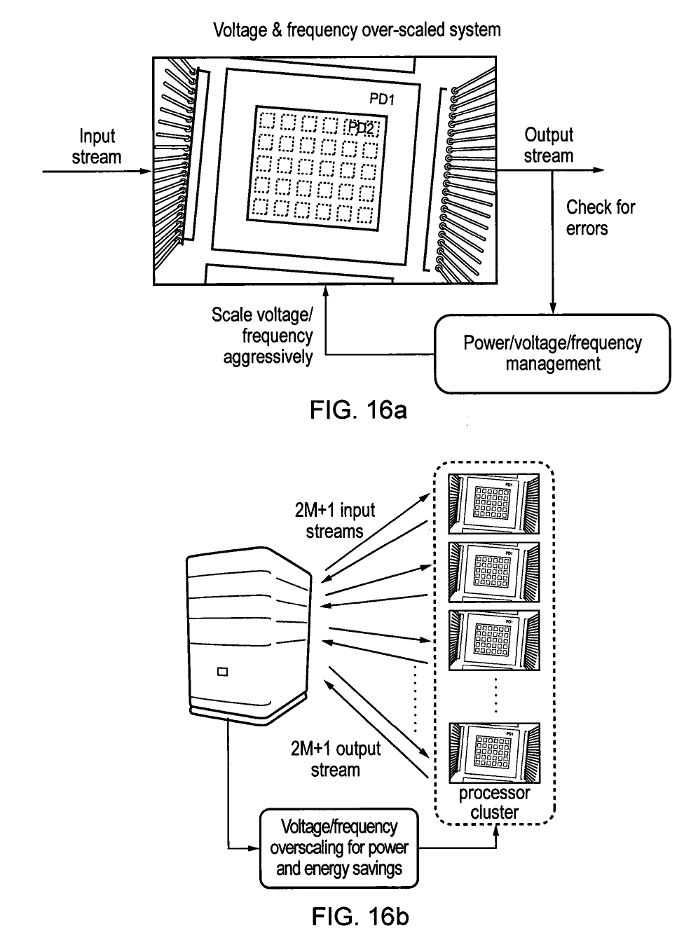

Hardware methods for such voltage and frequency scaling are quickly becoming the dominant approaches being deployed in real systems and applications. Traditional hardware methods [28][29] focus on: (i) reducing the voltage until memory or register failures occur and (ii) operating just above the safety margin to ensure error-free computation. The present invention can provide for systems that operate below the safety margin by allowing hardware faults to happen within LSB operations applied in 2M+1 streams of data and providing for a mechanism to reliably detect these faults and then recompute the erroneous results at higher voltage and/or lower frequency (where error-free operation is guaranteed by the hardware). This provides for a substantially more aggressive method for voltage and frequency scaling and thus enables power and energy savings that cannot be achieved with current methods, while at the same time ensuring reliable computation of the final results. A processor cluster implementing the present invention, as illustrated by FIG. 16a and FIG. 16b, would aggressively reduce voltage (for power savings), or increase processing frequency (for energy savings), even after errors are observed. Therefore, the present invention would allow for guaranteed reliability when hardware operates below its safety margins.

### Example Application 3: Computing with Faulty Hardware

Under the constantly-increasing CMOS integration densities, it is now well understood that it is increasingly difficult to maintain the strict quality-assurance guarantees for processor manufacturing below 22 nm [30]. For example, it has been reported that Intel and other processor manufacturers reject more than 10% of their manufactured chipsets from the foundry because they do not pass the quality assurance measures imposed for error-free operation for the entire lifetime of a chip. This has been contributing to exponentially-rising design, manufacturing and testing costs [30].

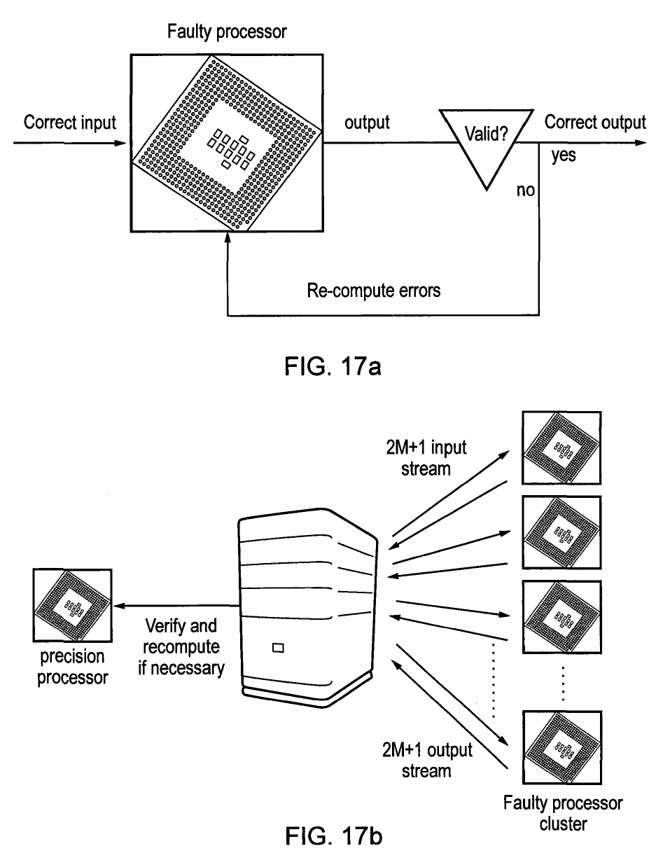

The present invention can provide for a solution where ageing or unreliable processor hardware, such as hardware that did not pass the quality assurance tests, is being used for LSB computations instead of being discarded. As an example, FIG. 17a and FIG. 17b, show a set of 2M+1 input data streams being sent to a processor cluster for LSB computations. The processor cluster comprises faulty chipsets that may occasionally fail. The returned 2M+1 output streams will thus (potentially) contain errors. However, the erroneous locations can be detected via the present invention and then be recomputed via a fault-free chipset.

### Example Application 4: Guaranteed Reliability for Safety Critical Applications

Beyond the power, reliability and encryption/obfuscation advantages offered by the invented approach within regular everyday computing systems, other domains where the present invention finds applicability are safety-critical, medical, automotive, space and military environments, where guaranteed reliability is mandated against a hostile computing environment and under sensitive computations that must be performed reliably.

Even though in a hostile environment like space or automotive operations, radiation-hardened devices and modular redundancy reduce the likelihood of permanent faults, transient faults are still an important concern [31]. For this reason, error control coding mechanisms [32] are heavily employed in both memory and processing units in satellite or automotive and military systems where cosmic radiation may cause unacceptable error rates [33]. The numerical entanglement method of the present invention can provide for viable alternative to traditional error-detection method and can guarantee reliability similar to dual modular redundancy at considerable lower implementation cost.

### Key Advantages

1) Complexity and System Benefits

The complexity of entanglement, disentanglement (recovery) and fault checking does not depend on the complexity of the operator op or on the length of the kernel (operand) g. The entangled inputs can be written in-place and no additional storage or additional operations are needed during the execution of the actual operation. In fact, the computational units performing the operation with kernel g are agnostic to the fact that their inputs are the entangled input streams and not the original input streams. Thus, the entangled computation shown in FIG. 2 can be executed concurrently in 2M+1 processing cores (that may be physically separate) and any memory optimization or other algorithmic optimization can be applied in the same manner as the original computation. For example, if an FFT routine is used for the calculation of convolution or cross-correlation of each input stream cₘ with kernel g, this routine can be used directly with the entangled input streams εₘ and kernel g.

2) Batch Versus Stream Processing

While FIG. 2 indicates the application of entanglement, computation, disentanglement and fault checking as a batch execution (one followed by the other), these can be performed in a streaming manner as data within each input stream is being read. That is, the entire process of FIG. 2 can be performed for all c_{m,n} (0≦m<2M+1) prior to utilizing inputs c_{m,n+1}. This is an important aspect that allows for memory-efficient operation and vectorization (for example, the usage of streaming SIMD instructions [17]) as it shows that the entire process of FIG. 2 does not require multiple passes over the input data streams.

3) Input Data Obfuscation

Finally, while ABFT/ECC and MR approaches do not alter the input data, numerical entanglement obfuscates the inputs by mixing pairs of input streams according to the entanglement parameters. This means that, if the entangled streams are placed in different, non-communicating, computation units, each unit cannot disentangle and extract any of the input data. Even if access to all entangled data is possible and even if M is known, since 2M(2M+1)! mixtures of pairs of inputs are possible and each mixture may utilize v possible settings (with v depending on the dynamic range of the inputs as discussed in the description to follow), if the entanglement mixture parameters are kept private the computation units performing the LSB processing will need to try 2vM(2M+1)! disentanglements to recover the results. For example, for M=14 and v=2 (equating to detection of one error every 29 inputs/outputs), this means that (approximately) 5×10³² possible permutations of disentanglements must be checked before the correct one is discovered. In a computer that could perform 1 peta disentanglements per second (10¹⁵—for a petascale computer) this would require more than 15.7 billion years. As such, this obfuscation property is useful for systems aiming for encrypted computation in that the LSB operations can be performed in entangled format in a potentially unreliable (and untrustworthy) computing system, such as a cloud computing infrastructure provided by a third party, while the entanglement, disentanglement and fault checking can be done in a trustworthy system that has access to the entanglement mixture parameters.

4) Dynamic Range Increase and Summary of all Methods

It is evident from this description that numerical entanglement circumvents the problems of ABFT, ECC and MR methods mentioned previously and indeed it may offer other advantages, such as encrypted computation. Its only remaining detriment is that the dynamic range of the entangled inputs εₘ is somewhat increased in comparison to the original inputs cₘ. However, as it will be demonstrated below, this increase depends on the amount of jointly-entangled inputs, i.e. the fault detection capability, and therefore one can be traded for the other.

### Complexity Analysis

Consider 2M+1 input integer data streams, each comprising N samples and consider that an LSB operation op with kernel g (which also has length N) is performed in each stream. This is the case, for example, under inner-products performed for matrix multiplication or convolution/cross-correlation between multiple input streams for similarity detection or filtering applications or matrix-vector products in Lanczos iterations and iterative methods [9]. If the kernel g has a substantially smaller length than the length of each input stream, the effective input stream size (N integer samples) can be adjusted to the kernel length under overlap-save or overlap-add operations in convolution and cross-correlation [21], and several (smaller) overlapping input blocks can be processed independently. Similarly, block-based processing can be implemented for memory efficiency, for example, in the case of block-major reordering in matrix multiplication [20][25][26] and memory-efficient transform decompositions. Thus, in the remainder of this section it is assumed that N expresses both the input data stream and the kernel length.

The operations count (additions/multiplications) for stream-by-stream sum-of-products between two square matrices comprising (2M+1)×(2M+1) sub-blocks of N×N integers is c_{GEMM}=(2M+1)³ N³. For sesquilinear operations like convolution and cross-correlation of 2M+1 input integer data streams (each comprising N samples) with kernel g (which also has length N), depending on the utilized realization, the number of operations can range from MN² for direct algorithms (for example, time-domain convolution) to MNlog₂N for fast algorithms (for example, FFT-based convolution) [21]. For example, for convolution or cross-correlation under these settings and an overlap-save realization for consecutive block processing, the number of operations (additions/multiplications) is c_{conv,time}=4(2M+1)N² for time domain processing and c_{conv,freq}=(2M+1)[(45N+15)log₂(3N+1)+3N+1] for frequency-domain processing.

As described above, numerical entanglement of 2M+1 input integer data streams (of N samples each) requires MN operations for the entanglement, disentanglement and fault checking per output sample. For example, ignoring all bit masking and bit-shifting operations (which take a negligible amount of time), the upper bound of the operations for numerical entanglement, disentanglement and fault checking is cₙₑ=(2M+1)(M+15)N. For the special case of the GEMM operation using (2M+1)×(2M+1) sub-blocks of N×N integers, the upper bound of the operations is: c_{ne,GEMM}=(2M+1)² (M+15)N². The percentile values obtained for

$$\frac{{C}_{ne , GEMM}}{{C}_{GEMM}} \times 100 \% , \frac{{C}_{ne}}{{C}_{conv , time}} \times 100 \% and \frac{{C}_{ne}}{{C}_{conv , freq}} \times 100 \%$$

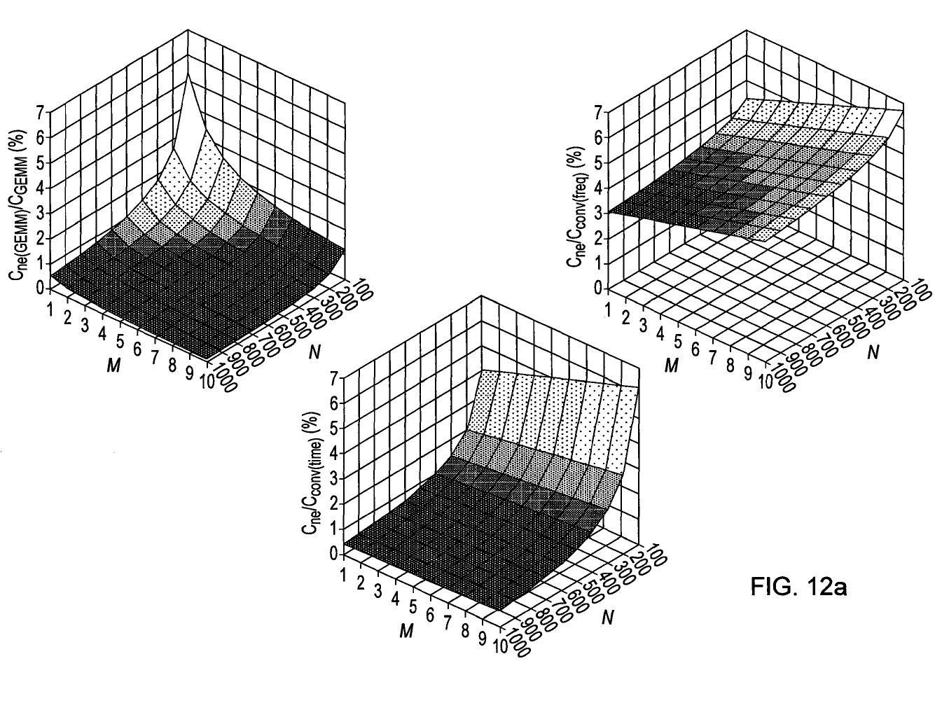

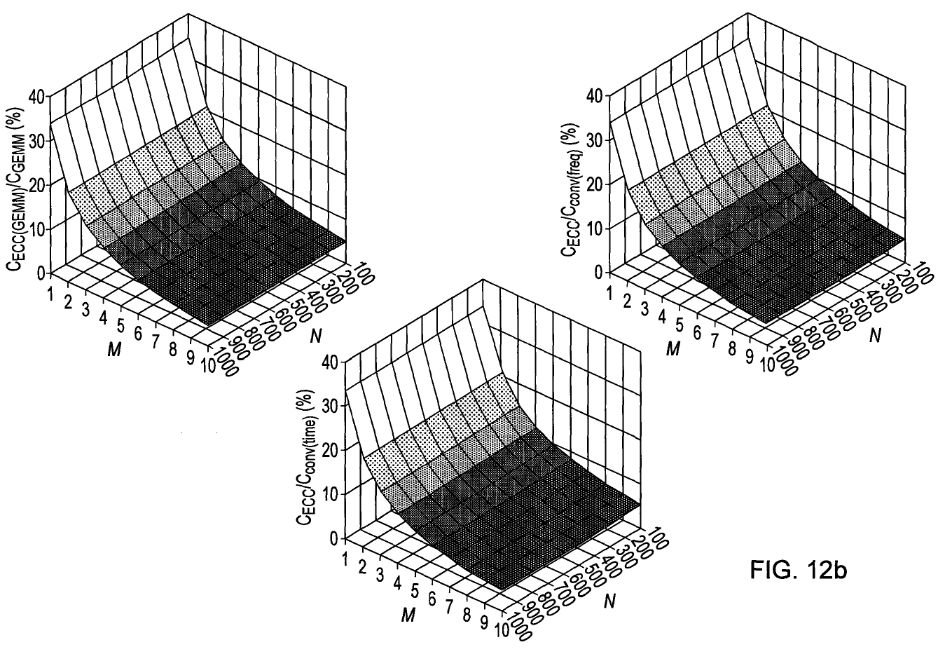

are presented in FIG. 12a for typical values of N and M. All subfigures demonstrate that for sesquilinear operations like matrix products, convolution and cross-correlation, the cost of numerical entanglement, disentanglement and fault checking is diminished when N increases, such that all ratios drop below 5% for N≧512. For comparison purposes, FIG. 12b shows the percentile overhead of high-redundant ECC/ABFT methods under the same range of values for N and M and the same fault-detection capability. Specifically, FIG. 12b shows the ratios

$$\frac{{C}_{ECC , GEMM}}{{C}_{GEMM}} \times 100 \% , \frac{{C}_{ECC , conv , time}}{{C}_{cov , time}} \times 100 \% and$$

$$\frac{{C}_{ECC , conv , freq}}{{C}_{conv , freq}} \times 100 \% ,$$

wherein C_{ECC,GEMM}, C_{ECC,conv,time} and C_{ECC,conv,freq} represent the overhead in terms of operations count (additions/multiplications) for each case. Evidently, the overhead of ECC/ABFT methods is constant for all N and does not decrease under complex LSB operations. Importantly, ECC/ABFT methods lead to very substantial overhead (above 10%) when high reliability is pursued, basically, when M≦4.

The comparison between FIG. 12a and FIG. 12b is illustrative of the capabilities unleashed by the proposed highly-reliable numerical entanglement. Evidently, in the present invention, the most-efficient operational area is the leftmost part of the plots, that is, small values of M and large values of N (small-size grouping of long streams of high-complex LSB operations). This area corresponds to the least-efficient operational area of high-redundant ECC/ABFT methods. The comparison between the two figures demonstrates that, for the same error detection capability (for example, 1 error in every 3 outputs, which corresponds to M=1), the present invention offers two orders of magnitude of complexity reduction against high-redundant ECC/ABFT. Conversely, the least-efficient operational area for the present invention is the rightmost part of the plots of FIG. 12a and FIG. 12b, that is, large values of M and small values of N (large-size grouping of short streams of low-complex LSB operations). This area corresponds to the most-efficient operational area of high-redundant ECC/ABFT methods. The comparison between the two figures demonstrates that, for the same error detection capability (for example, 1 error in every 21 outputs, which corresponds to M=10), the present invention offers only 30-60% complexity reduction against high-redundant ECC/ABFT. Thus, the present invention is maximally beneficial when high reliability is desired for complex LSB operations with very low implementation overhead.

This comparison can also be carried out against low-redundant ECC/ABFT methods. Specifically, under 1-5% of implementation overhead, FIG. 12a shows that the present invention can ensure the detection of one error in every three output streams under M=1 (per sample n). On the other hand, low-redundant ECC/ABFT would only be able to reliably detect one error in the entire set of output streams (per sample n). For medium to large-scale processing, that is to say, 100-1000 streams of data, this corresponds to the present invention offering 2-3 orders of magnitude of increase in error detection capability against low-redundant ECC/ABFT.

Initial Experimental Validation

Experiments were performed by running convolution operations via Intel's Integrated Performance Primitives (IPP) [27]. Intel IPP supports a large family of highly-optimized routines for integer-to-integer LSB processing for image and video filtering, processing and compression applications. In this example, the 16-bit signed-integer convolution routine (ippsConv_16s_Sfs) was used, wherein M=1 and l=5 for the proposed numerical entanglement approach. Results with an Intel i7-3632QM 2.2 GHz processor (Ivy Bridge architecture with AVX support, Windows operating system, Microsoft Visual Studio Compiler) demonstrated that for N≧512, the cycle overhead of performing entanglement, extraction and fault checking was found to be less than 5% of the cycle count for the convolution operation itself. This overhead diminishes to near-zero as the number of the LSB operations per input increases. At the same time, the present invention can guarantee the detection of any error within one out of the three entangled streams of data.

### Obfuscation in the Entangled Inputs/Outputs

The correct extraction of the results depends on the knowledge of the order via which the streams have been entangled. For example, in FIG. 10, the order of the top parts (Zones 1 to 4) of C_{α,n}, c_{β,n}, c_{γ,n}, c_{δ,n}, c_{ε,n} is c_{4,n}, c_{0,n}, c_{1,n}, c_{2,n}, c_{3,n}. However, any of their 5! permutations could be used, for example, c_{1,n}, c_{2,n}, c_{3,n}, c_{4,n}, c_{0,n} or c_{1,n}, c_{3,n}, c_{0,n}, c_{4,n}, c_{2,n} etc. Moreover, while the order of the bottom parts of the entangled inputs (Zones 0 to 3) must follow the chosen order of the top parts, their placement can be circularly shifted into any of the 4 positions that do not cause the top and bottom parts of the entanglements to match. Hence, if these entanglement mixture parameters (order of top and circular shift of bottom) are varied each time the entanglement process is performed and they are kept private, one would need to check all possible entanglements until the correct one is discovered.

In the general case of 2M+1 input streams comprising N integer samples each, (2M+1)! permutations of placements of the top parts of the entanglements are possible. For each placement of the top parts, 2M circular shifts are possible. This is because any placement allows for the checks of the present invention to be applied if and only if all input streams entangled at the bottom parts are following the order of the top parts and are circularly shifted into any position that does match the position of the top parts. Finally, if multiple groups of N integer samples are treated independently, as mentioned for example previously for overlap-save or overlap-add convolution or for matrix products with block-major reordering, each group can use a different combination of placements for the top and bottom parts of the entanglements. In addition, if space is available in the numerical representation to vary the zonal width of l bits, this provides for an additional degree of freedom in adjusting the placements of top and bottom parts within each entanglement. The total available combinations of the two latter parameters (number of blocks and zonal width adjustment) are represented by parameter v, v∈N. Thus, the overall number of possible combinations for entanglement parameters is 2vM(2M+1)!.

### CONCLUSION

In summary, the present invention provides a method of fault detection that ensures highly-reliable linear, sesquilinear and bijective (LSB) processing of integer data streams based on numerical entanglement. Under 2M+1 input data streams, the present invention provides: (i) guaranteed detection of any error within a single input/output stream; (ii) implementation complexity that depends only on M and not on the complexity of the performed LSB operations; and (iii) robust input/output obfuscation if the entanglement parameters are kept private.

Various modifications, whether by way of addition, deletion or substitution may be made to the above described embodiments to provide further embodiments, any and all of which are intended to be encompassed by the appended claims.

### REFERENCES

[1] M. Nicolaidis, et al., “Design for test and reliability in ultimate cmos,” in IEEE Design, Automation & Test in Europe Conference & Exhibition (DATE), 2012, pp. 677-682.
[2] B. Carterette, V. Pavlu, H. Fang, and E. Kanoulas, “Million query track 2009 overview,” in Proceedings of TREC, 2009, vol. 9.
[3] L. Page, S. Brin, R. Motwani, and T. Winograd, “The PageRank citation ranking: bringing order to the web.,” 1999.
[4] J. Yang, D. Zhang, A. F Frangi, and J.-Y. Yang, “Two-dimensional PCA: a new approach to appearance-based face representation and recognition,” IEEE Trans. on Patt. Anal. and Machine Intell., vol. 26, no. 1, pp. 131-137, 2004.
[5] G. Bradski and A. Kaehler, Learning OpenCV: Computer vision with the OpenCV library, O'Reilly Media, Incorporated, 2008.
[6] Y. Peng, B. Gong, H. Liu, and Y. Zhang, “Parallel computing for option pricing based on the backward stochastic differential equation,” in Springer High Perform. Comput. and Applic., pp. 325-330. 2010.
[7] Y. Oike and A. El Gamal, “CMOS image sensor with per-column ADC and programmable compressed sensing,” IEEE J. of Solid State Phys., vol. 48, no. 1, pp. 318-328, 2013.
[8] A. J Viterbi and J. K. Omura, Principles of digital communication and coding, Dover Publications, 2009.
[9] G. H Golub and C. F Van Loan, Matrix computations, Johns Hopkins University Press, 1996.
[10] J. S Yedidia, W. T Freeman, Y. Weiss, et al., “Generalized belief propagation,” Advances in neural information processing systems, pp. 689-695, 2001.
[11]G. Bosilca, R. Delmas, J. Dongarra, and J. Langou, “Algorithm-based fault tolerance applied to high performance computing,” Elsevier J. of Paral. and Distrib. Comput., vol. 69, no. 4, pp. 410-416, 2009.
[12]Z. Chen, G. E Fagg, E. Gabriel, J. Langou, T. Angskun, G. Bosilca, and J. Dongarra, “Fault tolerant high performance computing by a coding approach,” in Proc. 10th ACM SIGPLAN Symp. on Princip. and Pract. of Paral. Prog., 2005, pp. 213-223.
[13] C. Engelmann, H. Ong, and S. L Scott, “The case for modular redundancy in large-scale high performance computing systems,” in Proc. LASTED Internat. Conf., 2009, vol. 641, p. 046.
[14] H. M Quinn, A. De Hon, and N. Carter, “Ccc visioning study: system-level cross-layer cooperation to achieve predictable systems from unpredictable components,” Tech. Rep., Los Alamos National Laboratory (LANL), 2011.
[15] P. M. Fenwick, “The Burrows-Wheeler transform for block sorting text compression: principles and improvements,” The Computer Journal, vol. 39, no. 9, pp. 731-740, 1996.
[16]D. G Murray and S. Hand, “Spread-spectrum computation,” in Proc. USENIX 4th Conf. on Hot Topics in Syst. Dependab., 2008, pp. 5-9.
[17]N. Firasta, M. Buxton, P. Jinbo, K. Nasri, and S. Kuo, “Intel AVX: New frontiers in performance improvements and energy efficiency,” Intel White paper, 2008.
[18]D. Anastasia and Y. Andreopoulos, “Linear image processing operations with operational tight packing,” IEEE Signal Process. Lett., vol. 17, no. 4, pp. 375-378, 2010.
[19] Anardo, M. A. Anam, D. Anastasia, F. Verdicchio, and Y. Andreopoulos, “Highly-Reliable Integer Matrix Multiplication via Numerical Packing”, Proc. 19^{th} IEEE International On-Line Testing Symposium, IOLTS' 13, pp. 19-24, July 2013.
[20]D. Anastasia and Y. Andreopoulos, “Throughput-distortion computation of generic matrix multiplication: Toward a computation channel for digital signal processing systems,” IEEE Trans. on Signal Process., vol. 60, no. 4, pp. 2024-2037, 2012.
[21]M. A. Anam and Y. Andreopoulos, “Throughput scaling of convolution for error-tolerant multimedia applications,” IEEE Trans. on Multimedia, vol. 14, no. 3, pp. 797-804, 2012.
[22]A. Kadyrov and M. Petrou, “The “invaders” algorithm: Range of values modulation for accelerated correlation,” IEEE Trans. on Patt. Anal. And Machine Intell., vol. 28, no. 11, pp. 1882-1886, 2006.
[23]C. Lin, B. Zhang, and Y. F. Zheng, “Packed integer wavelet transform constructed by lifting scheme,” IEEE Trans. Circ. and Syst. for Video Technol., vol. 10, no. 8, pp. 1496-1501, 2000.
[24]J. D Allen, “An approach to fast transform coding in software,” Elsevier Signal Process.: Image Comm., vol. 8, no. 1, pp. 3-11, 1996.
[25]K. Goto and R. A Van De Geijn, “Anatomy of high-performance matrix multiplication,” ACM Trans. Math. Soft, vol. 34, no. 3, pp. 12, 2008.
[26] MKL Intel, “Intel math kernel library,” 2007.
[27]S. Taylor, Intel Integrated Performance Primitives: How to Optimize Software Applications Using Intel IPP, 2003.
[28] Alba, M. E. V.; Chua, A. N.; Lofamia, W. V. V.; Maestro, R. J. M.; Hizon, J. R. E.; Madamba, J. A. R.; Aquino, H. R. O.; Alarcon, L. P., “An aggressive power optimization of the ARM9-based core using RAZOR,” TENCON 2012-2012 IEEE Region 10 Conference, vol., no., pp. 1, 5, 19-22 Nov. 2012.
[29] Das, S.; Tokunaga, C.; Pant, S.; Wei-Hsiang Ma; Kalaiselvan, S.; Lai, K.; Bull, D. M.; Blaauw, D. T., “RazorII: In Situ Error Detection and Correction for PVT and SER Tolerance,” Solid-State Circuits, IEEE Journal of, vol. 44, no. 1, pp. 32, 48, January 2009.
[30] Intel Quality System Handbook, Intel Corp., December 2009 (http://www.intel.com/content/dam/doc/reference-guide/qualitv-system-handbook.pdf)
[31] Battezzati, N.; Gerardin, S.; Manuzzato, A.; Paccagnella, A.; Rezgui, S.; Sterpone, L.; Violante, M., “On the Evaluation of Radiation-Induced Transient Faults in Flash-Based FPGAs,” On-Line Testing Symposium, 2008. IOLTS '08. 14th IEEE International, vol., no., pp. 135, 140, 7-9 Jul. 2008.
[32] Kaneko, H., “Error control coding for semiconductor memory systems in the space radiation environment,” Defect and Fault Tolerance in VLSI Systems, 2005. DFT 2005. 20th IEEE International Symposium on, vol., no., pp. 93,101, 3-5 Oct. 2005.
[33] Nicolaidis, Michael, “Time redundancy based soft-error tolerance to rescue nanometer technologies”, VLSI Test Symposium, 1999. Proceedings. 17th IEEE, 86-94, 1999, IEEE.

1: A method of fault detection in data computations comprising:
performing a numerical entanglement process including receiving a plurality of data streams comprising a plurality of input data values, wherein each input data value is paired with a second input data value, and wherein, for each pair of input data values, one input data value is scaled with a predetermined factor and the other input data value is added or subtracted to produce a plurality of numerically entangled input data streams to be used in data computations that produce a plurality of numerically entangled output data streams;
performing a numerical disentanglement process on the plurality of numerically entangled output data streams, wherein in-stream positions of the numerically entangled input data values within each numerically entangled input data stream are mapped to the in-stream positions of the numerically entangled output data values within each numerically entangled output data stream, and wherein the numerical entanglement process is subsequently reversed based on the mapped positions to produce a plurality of numerically disentangled output data streams; and
performing a fault checking process on the plurality of numerically disentangled output data streams, wherein an intermediate form of the plurality of numerically entangled output data streams are produced, wherein the data values contained within corresponding locations and numerical ranges of each data stream of the intermediate form are compared to identify at least one fault in the data computation.

2: A method according to claim 1, wherein Mᵢₙ data streams of Nᵢₙ input data values are received.

3: A method according to claim 2, wherein Mᵢₙ>1, N₁ₙ>1 and Mᵢₙ+Nᵢₙ>3

4: A method according to claim 1, wherein the numerical entanglement process produces Mᵢₙ×Nᵢₙ numerically entangled inputs.

5: A method according to claim 2, wherein the data computations produce Mₒᵤₜ data streams of Nₒᵤₜ numerically entangled output data values, such that there are Mₒᵤₜ×Nₒᵤₜ numerically entangled outputs.

6: A method according to claim 1, wherein the data computations on the plurality of numerically entangled input data streams include performing at least one linear, sesquilinear, or bijective (LSB) operation.

7. (canceled)

8: A method according to claim 1, wherein the stream number and in-stream position of each pair of input data values, or the parameters of the process from which each pair of input data values is selected, are kept separate from the input data as a numerical entanglement key.

9: A method according to claim 1, wherein mapping the in-stream positions of the numerically entangled input data values within each of the numerically entangled input data streams to the in-stream positions of the numerically entangled output data values within each numerically entangled input data stream is conducted according to the order by which data computations were performed on the numerically entangled input data streams to produce the numerically entangled output data streams.

10: A method according to claim 2, wherein Mᵢₙ=2M+1 with M>1.

11: A method according to claim 10, wherein the fault of checking process includes 4M+3 checks for each group of 2M+1 numerically entangled output data streams.

12: A method according to claim 10, wherein the plurality of numerically entangled input data streams or output data streams are contained within a w-bit integer representation, wherein the dynamic range of the w-bit integer representation is larger or equal to (2M+1) l-bits, such that (2M+1)l≦w, and wherein the dynamic range of the numerically entangled data streams is not greater than (2M+1)l bits.

13: A method according to claim 12, wherein the fault checking process includes M intermediate steps for each numerically entangled output data value of each 2M+1 numerically entangled output data stream, each intermediate step producing another 2M+1 numerically entangled output data streams wherein the offset between the 2M+1 numerically entangled output data streams increases by l-bits with each intermediate step.

14: A method according to claim 12, wherein the numerical entanglement process includes scaling one input data value within the pairs of input data values by a factor dependent on l, and subsequently adding or subtracting the second input data value within the pair.

15: A method according to any claim 12, wherein the numerically entangled input data streams have an increased dynamic range in comparison to the input data values by a factor dependent on l-.

16: A method according to any of claim 12, wherein the numerical disentanglement process if further based on the application of at least one of scaling by a factor dependent on l, addition operations, subtraction operations, modulo operations or bit-masking operations.

17: A method according to claim 12, wherein producing the intermediate form of the plurality of numerically disentangled output data streams is based on the in-stream positions of the numerically entangled input data values within the numerically entangled input data streams, and is further performed by scaling the numerically entangled output data values with a factor dependent on l.

18: A method according to claim 12, wherein the input data values comprise signed or unsigned integer numbers and the process of numerical entanglement includes linear combinations of pairs of input data values, wherein one input data value is left-shifted by l bits using a shift register and added to another input data value to form a single numerically entangled input data value.

19: A method according to claim 1, wherein the fault checking process includes checking that the data values contained within corresponding locations and numerical ranges of each numerically entangled output data stream of the intermediate form are identical.

20: A method according to claim 19, wherein data values contained within corresponding locations and numerical ranges of each numerically entangled output data stream of the intermediate form that are not identical indicate the presence of a fault.

21: A method according to claim 1, wherein the selection of pairs of input data values is performed by repeating the following steps until all of the available input data values have been selected:
(a) selecting at random one input data stream from the plurality of input data streams, but excluding previously selected input data streams;
(b) within each selected input data stream, selecting each of its input 15 data values sequentially or via some fixed pattern;
(c) pairing each selected input data value with a second input data value, wherein the second input data value is selected from the corresponding position of the next input data stream; and
(d) keeping the positions of each pair of input data values, or the manner via which the random selection is performed, as a numerical entanglement key.

22-23. (canceled)

24: A method according to claim 1, wherein the steps of numerical entanglement, processing, numerical disentanglement and fault checking are all performed on one group of input data streams before being applied to the remaining input data streams.

25: A method according to claim 1, wherein the steps of numerical entanglement, processing, numerical disentanglement and fault checking are sequentially performed on all of the received input data streams.

26: A method according to claim 3, wherein Mᵢₙ numerically entangled input data streams are produced in a secure or trustworthy system, the parameters of the numerical entanglement process being kept in the secure or trustworthy system, and data computations being performed on M′ᵢₙ out of the Mᵢₙ numerically entangled input data streams, wherein 1<M′ᵢₙ<Mᵢₙ, in the secure or trustworthy system, and wherein data computations are performed on the remaining Mᵢₙ-M′ᵢₙ numerically entangled input data streams in an insecure or untrustworthy system.

27: A method according to claim 3, wherein Mₘ numerically entangled input data streams are produced and data computations are performed on the numerically entangled input data streams by a separate apparatus over a computer network, or by a cloud computing infrastructure, or by a separate processor core over a multicore or manycore computing system, wherein such apparatus are unreliable and/or untrustworthy.

28: An apparatus for detecting faults in data computations, comprising:
means for receiving a plurality of data streams comprising a plurality of input data values;
means for producing a plurality of numerically entangled input data streams, wherein each received input data value is paired with a second input data value, and wherein, for each pair of input data values, one input data value is scaled with a predetermined factor, and wherein the second input data value is subsequently added or subtracted to produce the plurality of numerically entangled input data streams to be used in data computations that produce a plurality of numerically entangled output data streams;
means for performing a numerical disentanglement process on the plurality of numerically entangled output data streams, wherein in-stream positions of the numerically entangled input data values within each numerically entangled input data stream are mapped to the in-stream positions of the numerically entangled output data values within each numerically entangled output data stream, and wherein the numerical entanglement process is subsequently reversed based on the mapped positions to produce a plurality of numerically disentangled output data streams; and
means for performing a fault checking process on the plurality of numerically disentangled output data streams, wherein an intermediate form of the plurality of numerically disentangled output data streams are produced, wherein the data values contained within corresponding locations and numerical ranges of each data stream of the intermediate form are compared to identify at least one fault in the data computation.

29: An apparatus for performing computations on data and detecting faults, comprising:
a processor;
a computer readable medium, the computer readable medium storing one or more machine instruction(s) is arranged such that when executed the processor is caused to carry out the method of claim 1.

30-56. (canceled)

57: A fault detection method for detecting faults in data computations, comprising: receiving a plurality of input data words intended as operands in a data computation to be performed;
mixing elements of the plurality of data words together in a predetermined manner to produce a plurality of mixed data words to be used as operands in one or more data computations, the computations providing a plurality of output mixed data words; separating the plurality of output mixed data words into a plurality of output data words; and
checking for faults in the one or more computations by evaluating one or more predefined numerical expressions using elements of the output data words as variables therein.

58: A method according to claim 57, wherein a fault is detected if the predefined numerical expressions are found to be true.

59: A method according to claim 57, wherein the mixing comprises pairing an element of the plurality of input data words with a second element of the plurality of input data words, and wherein, for a pair of elements, one element is scaled with a predetermined factor and added or subtracted to the element to produce the plurality of mixed input data words.

60: A method according to claim 57, wherein the separating comprises mapping the positions of the elements within the plurality of mixed input data words to the positions of the elements within the plurality of mixed output data words, whereby the mixing is subsequently reversed.

61: A method according to claim 57, wherein the checking includes producing an intermediate form of the plurality of mixed output data words, wherein the elements contained within corresponding locations and numerical ranges of each data word of the intermediate form are compared to identify at east one fault in the one or more data computations.

62: A method according to claim 61, wherein the presence of a fault is indicated if elements within corresponding locations and numerical ranges of each data word of the intermediate form are not identical.

63: A method according to claim 57, wherein the one or more data computations include at east one linear, sesquilinear or bijective (LSB) operation.

64: A method according to claim 60, wherein the position of each pair of elements within the plurality of mixed input data words, or the parameters of the process from which each pair of elements is selected, are kept separate from the input data as a mixing key.

65: An apparatus for performing computations on data and detecting faults, comprising:
a processor;
a computer readable medium, the computer readable medium storing one or more machine instruction(s) arranged such that when executed the processor is caused to carry out the fault detection method of claim 57.
